(19) United States
(12) Patent Application Publication
(10) Pub. No.: US 2024/0411661 A1
(43) Pub. Date: Dec. 12, 2024

(54) APPARATUS AND METHOD FOR PROVIDING USER INTERFACE COMPRISING BENCHMARK RESULT OF ARTIFICIAL INTELLIGENCE BASED MODEL

(71) Applicant: NOTA, INC., Daejeon (KR)

(72) Inventor: Sanggeon PARK, Seoul (KR)

(21) Appl. No.: 18/491,645

(22) Filed: Oct. 20, 2023

(30) Foreign Application Priority Data
Jun. 9, 2023 (KR) 10-2023-0073909

(51) Int. Cl. G06F 11/34

(52) U.S. Cl. CPC G06F 11/3428

(57) ABSTRACT

Disclosed is a method for providing a benchmark result, which is performed by a computing device. The method may include obtaining a benchmark object comprising an artificial intelligence-based target model and a target node. The method may include obtaining a benchmark configuration setting indicating a customization of the benchmark result. The benchmark configuration setting comprises at least one of: a resource condition for the target node, a first comparison option for benchmark results of each of a plurality of layers constituting the target model, or a second comparison option for benchmark results of each of a plurality of nodes comprising the target node. The method may include providing the benchmark result based on the configuration setting, the target model, and the target node.

### CROSS-REFERENCE TO RELATED APPLICATIONS

This application claims priority to and the benefit of Korean Patent Application No. 10-2023-0073909 filed in the Korean Intellectual Property Office on Jun. 9, 2023, the entire contents of which are incorporated herein by reference.

### BACKGROUND

### Technical Field

The present disclosure relates to artificial intelligence technology, and more particularly, to benchmark technology for an artificial intelligence-based model.

### Description of the Related Art

As the demand for edge technology or edge artificial intelligence technology that can perform direct calculations on a network terminal such as personal computers, smart phones, cars, wearable devices, and robots increase, the research and developments of models that take hardware resources into account are made.

US patent publication No. US2022-0121927 discloses providing a group of neural networks for processing data in a plurality of hardware environments.

### BRIEF SUMMARY

As the importance of hardware increases in the field of artificial intelligence technology along with the development of edge technology, sufficient knowledge is required not only about the model itself but also about the various hardware on which artificial intelligence-based models will be executed. For example, the inventors of the present disclosure have appreciated that even if there is a model with excellent performance in a specific domain, inference performance for these models can be different for each hardware where the model is to be executed. There can also be a situation in which a model having optimal performance is not supported in specific hardware in which a service is to be provided in a specific domain. Accordingly, in order to determine the artificial intelligence-based model suitable for the service to be provided and hardware suitable for the artificial intelligence-based model together, high levels of background knowledge and vast amounts of resources for the artificial intelligence technology and hardware technology can be required.

The present disclosure has been made in an effort to efficiently provide a benchmark result of a specific model in a specific node. The present disclosure can effectively provide a benchmark result or a benchmark estimation result of an artificial intelligence-based model. The present disclosure can improve a user experience with a benchmark result of an artificial intelligence-based model.

However, technical objects of the present disclosure are not restricted to a technical object mentioned above, and other technical objects not mentioned will be able to be apparently appreciated by those skilled in the art.

An exemplary embodiment of the present disclosure provides a method for providing a benchmark result, performed by a computing device. The method may include: obtaining a benchmark object comprising an artificial intelligence-based target model and a target node, and obtaining a benchmark configuration setting indicating a customization of the benchmark result, wherein the benchmark configuration setting comprises at least one of: a resource condition for the target node, a first comparison option for benchmark results of each of a plurality of layers constituting the target model, or a second comparison option for benchmark results of each of a plurality of nodes comprising the target node; and providing the benchmark result based on the configuration setting, the target model, and the target node.

In an exemplary embodiment, the resource condition for the target node comprises: a condition related to a use of computing resources by applications other than an inference application of the target model on the target node, or a condition related to a use of computing resources by operations other than an inference operation of the target model on the target node, when inference of the target model is executed on the target node, and the benchmark result comprises performance information obtained by executing the target model on the target node assuming a computing resource situation corresponding to the resource condition.

In an exemplary embodiment, the resource condition for the target node comprises a condition related to an occupancy of computing resources being used on the target node, when inference of the target model is to be executed on the target node.

In an exemplary embodiment, the resource condition for the target node identifies a computing resource to be included in the benchmark result, when inference of the target model is to be executed on the target node.

In an exemplary embodiment, the first comparison option is an option for visually comparing benchmark results for each of the plurality of layers within the target model at the target node, and the benchmark results comprise performance information corresponding to each of the plurality of layers constituting the target model.

In an exemplary embodiment, the benchmark result comprises a benchmark estimation result predicted when the target model is executed in the target node.

In an exemplary embodiment, wherein the second comparison option is an option for visually comparing benchmark results for the target model at each of the plurality of nodes comprising the target node, or an option for visually comparing benchmark results for each of the plurality of layers within the target model at each of the plurality of nodes comprising the target node.

In an exemplary embodiment, the benchmark configuration setting further comprises a third comparison option for visually comparing benchmark results for each of a plurality of models comprising the target model at the target node.

In an exemplary embodiment, the benchmark result comprises the number of calls to each of the plurality of layers, and latencies for each of the plurality of layers.

In an exemplary embodiment, a layer that is able to be optimized and a layer that is not able to be optimized, for each of a plurality of layers constituting an artificial intelligence-based model, can be distinguishably displayed in the benchmark result.

In an exemplary embodiment, the benchmark result comprises: preprocessing time information required for preprocessing of inference of the target model at the target node, or inference time information required for inference of the target model at the target node; and preprocessing memory usage information used for preprocessing of inference of the target model at the target node, or inference memory usage information required for inference of the target model at the target node.

In an exemplary embodiment, the benchmark result comprises: memory footprint information required for executing the target model at the target node; latency information required for executing the target model at the target node; and power consumption information required for executing the target model at the target node.

In an exemplary embodiment, the benchmark result comprises at least one of: a first result comparatively indicating maximum inference latencies obtained by executing the target model assuming the slowest computing resource situation at each of the plurality of nodes comprising the target node; a second result comparatively indicating an average inference latency when the target model is executed multiple times at each of the plurality of nodes comprising the target node; or a third result comparatively indicating inference latencies for each of a plurality of layers within the target model at each of the plurality of nodes comprising the target node.

In an exemplary embodiment, the benchmark result comprises: a fourth result comparatively indicating a processor margin value in which another operation or another application is executable in a process of inferring the target model at the target node; and a fifth result comparatively indicating a memory margin value in which another operation or another application is executable in a process of inferring the target model at the target node.

In an exemplary embodiment, the providing the benchmark result comprises: determining a visual element to be included in the benchmark result based on the benchmark configuration setting; obtaining performance information to be included in the benchmark result based on the target model and the target node; and providing the benchmark result in which the performance information is indicated depending on the visual element.

In an exemplary embodiment, the visual element comprises: information identifying each of a plurality of axes to be included in the benchmark result; and information identifying a graph shape to be included in the benchmark result.

In an exemplary embodiment, the providing the benchmark result comprises: providing, to a first module, the benchmark result comprising performance information corresponding to an input layer of the plurality of layers so that the first module which trains the target model can determine a size of input data of the target model; or providing, to a second module, the benchmark result comprising performance information for each of the plurality of layers so that the second module which generates a compressed target model by compressing the target model can determine whether to compress each of the plurality of layers of the target model.

In an exemplary embodiment, the method further comprises: obtaining importance level information corresponding to visual elements to be included in the benchmark result; and providing a candidate node list comprising candidate nodes recommended for determining the target node, by using pre-obtained benchmark results for each of a plurality of nodes based on the importance level information.

In an exemplary embodiment, the benchmark configuration setting further comprises target area information for identifying a target area which is an object of a benchmark within the target model, and the benchmark result comprises estimated performance information corresponding to the identified target area when the benchmark is performed at the target node.

In an exemplary embodiment, a computer readable medium storing a computer program is disclosed. For instance, a computer readable medium may be a non-transitory computer readable medium. The computer program allows a computing device to perform following operations to provide a benchmark result when executed by the computing device. The operations comprise: obtaining a benchmark object comprising an artificial intelligence-based target model and a target node, and obtaining a benchmark configuration setting indicating a customization of the benchmark result, wherein the benchmark configuration setting comprises at least one of: a resource condition for the target node, a first comparison option for benchmark results of each of a plurality of layers constituting the target model, or a second comparison option for benchmark results of each of a plurality of nodes comprising the target node; and providing the benchmark result based on the configuration setting, the target model, and the target node.

In an exemplary embodiment, a computing device for providing a benchmark result is disclosed. A computing device comprises at least one processor; and a memory. The at least one processor: obtains a benchmark object comprising an artificial intelligence-based target model and a target node, and obtaining a benchmark configuration setting indicating a customization of the benchmark result, wherein the benchmark configuration setting comprises at least one of: a resource condition for the target node, a first comparison option for benchmark results of each of a plurality of layers constituting the target model, or a second comparison option for benchmark results of each of a plurality of nodes comprising the target node; and provides the benchmark result based on the configuration setting, the target model, and the target node.

According to an exemplary embodiment of the present disclosure, a technique can provide a benchmark result of a specific model in a specific node in an efficient scheme.

According to an exemplary embodiment of the present disclosure, a technique can improve a user experience by providing a benchmark result of a specific model in a specific node in an efficient scheme.

### BRIEF DESCRIPTION OF THE SEVERAL VIEWS OF THE DRAWINGS

FIG. 1 schematically illustrates a block diagram of a computing device according to an exemplary embodiment of the present disclosure.

FIG. 2 illustrates an exemplary structure of an artificial intelligence based model according to an exemplary embodiment of the present disclosure.

FIG. 3 is an exemplary schematic view for a system for providing a benchmark result according to an exemplary embodiment of the present disclosure.

FIG. 4 illustratively illustrates a method for providing a benchmark result according to an exemplary embodiment of the present disclosure.

FIG. 5 illustratively illustrates a method for providing a benchmark result according to an exemplary embodiment of the present disclosure.

FIG. 6 illustratively illustrates a benchmark result to which a visual element is applied according to an exemplary embodiment of the present disclosure.

FIG. 7 illustratively illustrates a benchmark result to which a visual element is applied according to an exemplary embodiment of the present disclosure.

FIG. 8 illustratively illustrates a benchmark result to which a visual element is applied according to an exemplary embodiment of the present disclosure.

FIG. 9 illustratively illustrates a benchmark result to which a visual element is applied according to an exemplary embodiment of the present disclosure.

FIG. 10 is a schematic view of a computing environment according to an exemplary embodiment of the present disclosure.

### DETAILED DESCRIPTION

Various exemplary embodiments will be described with reference to drawings. In the specification, various descriptions are presented to provide appreciation of the present disclosure. Prior to describing detailed contents for carrying out the present disclosure, it should be noted that configurations not directly associated with the technical gist of the present disclosure are omitted without departing from the technical gist of the present disclosure. Further, terms or words used in this specification and claims should be interpreted as meanings and concepts which match the technical spirit of the present disclosure based on a principle in which the inventor can define appropriate concepts of the terms in order to describe his/her disclosure by a best method.

“Module,” “system,” and the like which are terms used in the specification refer to a computer-related entity, hardware, firmware, software, and a combination of the software and the hardware, or execution of the software, and interchangeably used. For example, the module may be a processing procedure executed on a processor, the processor, an object, an execution thread, a program, application and/or a computing device, but is not limited thereto. One or more modules may reside within the processor and/or a thread of execution. The module may be localized in one computer. One module may be distributed between two or more computers. Further, the modules may be executed by various computer-readable media having various data structures, which are stored therein. The modules may perform communication through local and/or remote processing according to a signal (for example, data from one component that interacts with other components and/or data from other systems transmitted through a network such as the Internet through a signal in a local system and a distribution system) having one or more data packets, for example.

Moreover, the term “or” is intended to mean not exclusive “or” but inclusive “or.” That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” and “at least one” used in this specification designates and includes all available combinations of one or more items among enumerated related items. For example, the term “at least one of A or B” or “at least one of A and B” should be interpreted to mean “a case including only A,” “a case including only B,” and “a case in which A and B are combined.”

Further, it should be appreciated that the term “comprise/include” and/or “comprising/including” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

Those skilled in the art need to recognize that various illustrative logical components, blocks, modules, circuits, means, logics, and algorithms described in connection with the exemplary embodiments disclosed herein may be additionally implemented as electronic hardware, computer software, or combinations of both sides. To clearly illustrate the interchangeability of hardware and software, various illustrative components, blocks, means, logics, modules, circuits, and steps have been described above generally in terms of their functionalities. Whether the functionalities are implemented as the hardware or software depends on a specific application and design restrictions given to an entire computing device.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

Terms expressed as N-th such as first, second, or third in the present disclosure are used to distinguish at least one entity. For example, entities expressed as first and second may be the same as or different from each other.

The term “benchmark” used in the present disclosure may mean an operation of executing or testing the model on a node, or an operation of measuring the performance of the node of the model.

In the present disclosure, a benchmark result or benchmark result information may include information that is acquired according to the benchmark, or information acquired by processing the information acquired according to the benchmark.

In an exemplary embodiment, the benchmark result or benchmark result information may include performance information or estimated performance information obtained as the model is executed in the node.

In an exemplary embodiment, the benchmark result or benchmark result information may include performance information anticipated when the model is executed in the node. For example, the benchmark result or benchmark result information may mean a benchmark result predicted when the model is executed in the node. For example, the benchmark result may correspond to anticipated performance information obtained based on a result of executing the model in the node in the past.

The term “model” used in the present disclosure may be used as a meaning that encompasses the artificial intelligence based model, the artificial intelligence model, the computation model, the neural network, a network function, and the neural network. In an exemplary embodiment, the model may mean a model file, identification information of the model, an execution configuration of the model, and a framework of the model. For example, TensorRT, Tflite, and/or Onnxruntime may correspond to the model.

The term “node” used in the present disclosure may correspond to hardware or hardware identification information in which the benchmark for the model is to be performed. The hardware may be used as a meaning that encompasses physical hardware, virtual hardware, hardware which is impossible to be accessed through the network from the outside, hardware which is impossible to confirm externally, and/or hardware which is confirmed in a cloud. For example, the node in the present disclosure may include various types of hardware such as Jetson Nano, Jetson Xavier NX, Jetson TX2, Jetson AGX Xavier, Jetson AGX Orin, GPU AWS-T4, Xcon-W-2223, Raspberry Pi Zero, Raspberry Pi 2W, Raspberry Pi 3B+, Raspberry Pi Zero 4B, and Mobile.

A layer in the present disclosure may be used to mean a component constituting the model. For example, one model may include a plurality of layers. For example, the plurality of layers may be connected to each other through an edge. An operation of the model may be performed through a computation performed in the plurality of layers. For example, the layer may be interchangeably used with an operator of the model. As an example, a convolutional layer included in a model that performs object recognition in an image by receiving the image may become an example for the layer in the model.

A benchmark query in the present disclosure may correspond to input data for requesting the benchmark result. As an example, the benchmark query may include information on a target model to be benchmarked and a target node in which the target model is to be executed. As an example, the benchmark query may include requesting a specific area in the target model to be benchmarked and performance information for the area. As an example, the benchmark query may be obtained based on a user input.

In an exemplary embodiment, the benchmark query may include an input for requesting a customized benchmark result. For example, an input for requesting the customized benchmark result may include a benchmark configuration setting.

In an exemplary embodiment, the benchmark configuration setting may mean an arbitrary type user setting for a configuration in which the benchmark is performed. For example, the benchmark configuration setting may include a resource condition for a target node, a first comparison option for the benchmark result of each of the plurality of layers constituting the target model, and/or a second comparison option for the benchmark result of each of a plurality of nodes including a target node.

A technique according to an exemplary embodiment of the present disclosure may provide a benchmark result in which a user experience is maximized through a benchmark configuration setting that assumes various computing resource situations and/or designation of various types of comparison options.

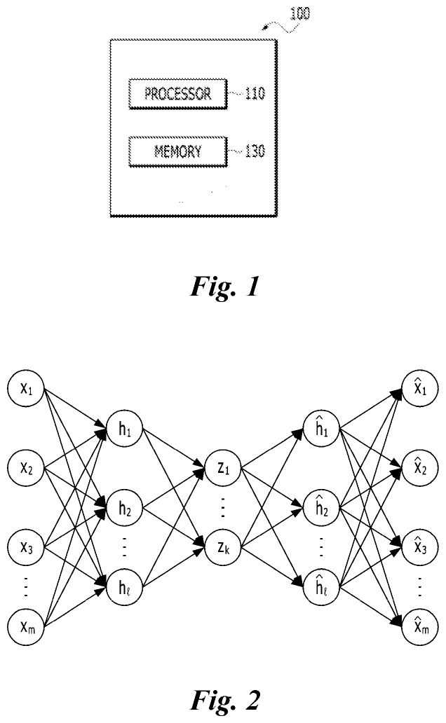

FIG. 1 schematically illustrates a block diagram of a computing device 100 according to an exemplary embodiment of the present disclosure.

According to the exemplary embodiment of the present disclosure, a computing device 100 may include a processor 110 and a memory 130.

A configuration of the computing device 100 illustrated in FIG. 1 is only an example shown through simplification. In an exemplary embodiment of the present disclosure, the computing device 100 may include other components for performing a computing configuration of the computing device 100 and only some of the disclosed components may constitute the computing device 100.

The computing device 100 in the present disclosure may be used as a meaning that encompass any type of server and any type of terminal.

In the present disclosure, the computing device 100 may mean any type of component constituting a system for implementing exemplary embodiments of the present disclosure.

The components of the computing device 100 illustrated in FIG. 1 may be exemplary and some components may be excluded, or an additional component may be included in the computing device 100. As an example, when the computing device 100 includes a user terminal, an output unit (not illustrated) and an input unit (not illustrated) may be included in a scope of the computing device 100.

In an exemplary embodiment, the computing device 100 may mean a device that manages and/or performs the benchmark for a plurality of nodes of a specified artificial intelligence-based model in communication with a plurality of devices. For example, the computing device 100 may refer to a device for managing a device farm. In another example, the computing device 100 may also correspond to the device farm.

In an exemplary embodiment, the computing device 100 may interact with an input from a user. For example, the computing device 100 may generate or obtain a benchmark result corresponding to a benchmark query requested from the user. For example, the computing device 100 may provide the benchmark result in response to the benchmark query obtained from the user. As an example, based on a purpose to use the benchmark result included in the benchmark query, information included in the benchmark result may be varied. As an example, based on the benchmark configuration setting included in the benchmark query, the information included in the benchmark result may be varied. As an example, based on identification information of a module that triggers the benchmark included in the benchmark query, the information included in the benchmark result may be varied.

In an exemplary embodiment, the computing device 100 may generate a learning model, generate a compressed model, and generate download data for deploying the model.

In an exemplary embodiment, the computing device 100 may manage and/or perform the benchmark for the plurality of devices the artificial intelligence-based model.

In an exemplary embodiment, the computing device 100 may also mean a device that generates the learning model through modeling for an input dataset, generates a lightweight model through compression for an input model, and/or generates download data so as to deploy the input model in a specific node. In an additional exemplary embodiment, the computing device 100 may be capable of interacting with another device that generates learning data, generates the lightweight model, and/or generates the download data.

In the present disclosure, deploy or deployment may mean any type of activity which enables using software (e.g., model). For example, the deploy or deployment may be interpreted as an overall process customized according to specific requirements or characteristics of the model or node. An example for the deploy or deployment may include release, installation and activation, deactivation, removal, update, built-in update, adaptation, and/or version tracking.

According to an exemplary embodiment of the present disclosure, the computing device 100 may generate or obtain anticipated performance information corresponding to an area and/or a scope based on a benchmark query for designating an area of the benchmark and/or a scope of the benchmark. For example, the computing device 100 may determine at least one target block to be used for obtaining the anticipated performance information corresponding to the benchmark query among a plurality of prestored blocks, and obtain the anticipated performance information corresponding to the benchmark query by using a benchmark result related to at least one determined target block.

According to an exemplary embodiment of the present disclosure, the computing device 100 may perform a preliminary task for obtaining the anticipated performance information. For example, the preliminary task may include a task of dividing the components of the model, and generating performance information for the divided models. For example, the computing device 100 may combine the layers constituting the model by the unit of the block, and generate and store the benchmark result based on the block. For example, the computing device 100 may store performance measurement information by the unit of a block constituted by the layer and the edge connecting the layers. The computing device 100 may obtain anticipated performance information corresponding to a subsequent benchmark query by using the stored performance measurement information.

In an additional exemplary embodiment, the computing device 100 may determine whether to convert an artificial intelligence-based model based on model type information of the artificial intelligence-based model, which is input for the benchmark and target type information identifying a model type to be benchmarked, and provide a candidate node list including candidate nodes determined based on the target type information, and determine, based on input data for selecting at least one target node in the candidate node list, the at least one target node, and provide a benchmark result obtained as a target model obtained according to whether to convert the artificial intelligence-based model is executed in the at least one target node.

In an exemplary embodiment, the computing device 100 may obtain input data including an inference task and a dataset, determine a target model to be benchmarked for the inference task and at least one target node in which the inference task of the target model is to be executed, and generate a benchmark result obtained as the target model is executed in at least one target node. As an example, the benchmark result, may be generate by the unit of the layer constituting the model or by the unit of the block constituted by the layer or the edge.

In an additional exemplary embodiment, the computing device 100 may receive, from another computing device including a plurality of modules that performs different operations related to the artificial intelligence-based model, module identification information indicating which module among the plurality of modules of another computing device is to trigger a benchmark operation of the computing device 100, and provide the benchmark result to another computing device based on the module identification information. Here, the benchmark result provided to another computing device may vary depending on the module identification information.

In an additional exemplary embodiment of the present disclosure, the computing device 100 may also obtain the benchmark result from another computing device or an external entity.

In an additional exemplary embodiment of the present disclosure, the computing device 100 may also obtain a result of converting the model from another computing device or an external entity (e.g., a converting device).

In an exemplary embodiment, the computing device 100 may obtain a benchmark object including the artificial intelligence-based target model and target node, obtain a benchmark configuration setting for designating customizing of the benchmark result, and provide the benchmark result based on the benchmark configuration setting, the target model, and the target node.

In an exemplary embodiment, the processor 110 may be constituted by at least one core and may include processors for data analysis and/or processing, which include a central processing unit (CPU), a general purpose graphics processing unit (GPGPU), a tensor processing unit (TPU), and the like of the computing device 100.

The processor 110 may read a computer program stored in the memory 130 to provide the benchmark result according to an exemplary embodiment of the present disclosure.

According to an exemplary embodiment of the present disclosure, the processor 110 may also perform a computation for learning a neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, and TPU of the processor 110 may process learning of a network function. For example, both the CPU and the GPGPU may process the learning of the network function and data classification using the network function. Further, in an exemplary embodiment of the present disclosure, processors of the plurality of computing devices may be used together to process the learning of the network function and the data classification using the network function. Further, the computer program executed in the computing device 100 according to an exemplary embodiment of the present disclosure may be a CPU, GPGPU, or TPU executable program.

Additionally, the processor 110 may generally process an overall operation of the computing device 100. For example, the processor 110 processes data, information, signals, and the like input or output through the components included in the computing device 100 or drives the application program stored in a storage unit to provide information or a function appropriate for the user.

According to an embodiment of the present disclosure, the memory 130 may store any type of information generated or determined by the processor 110 or any type of information received by the computing device 100. According to an exemplary embodiment of the present disclosure, the memory 130 may be a storage medium that stores computer software which allows the processor 110 to perform the operations according to the exemplary embodiments of the present disclosure. Therefore, the memory 130 may mean computer-readable media for storing software codes required for performing the exemplary embodiments of the present disclosure, data which become execution targets of the codes, and execution results of the codes.

According to an exemplary embodiment of the present disclosure, the memory 130 may mean any type of storage medium, and include, for example, at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the memory 130 used in the present disclosure is not limited to the examples.

In the present disclosure, the communication unit (not illustrated) may be configured regardless of communication modes such as wired and wireless modes and constituted by various communication networks including a personal area network (PAN), a wide area network (WAN), and the like. Further, the network unit 150 may operate based on known World Wide Web (WWW) and may adopt a wireless transmission technology used for short-distance communication, such as infrared data association (IrDA) or Bluetooth.

The computing device 100 in the present disclosure may include any type of user terminal and/or any type of server. Therefore, the exemplary embodiments of the present disclosure may be performed by the server and/or the user terminal.

In an exemplary embodiment, the user terminal may include any type of terminal which is capable of interacting with the server or another computing device. The user terminal may include, for example, a mobile phone, a smart phone, a laptop computer, personal digital assistants (PDA), a slate PC, a tablet PC, and an ultrabook.

In an exemplary embodiment, the server may include, for example, any type of computing system or computing device such as a microprocessor, a mainframe computer, a digital processor, a portable device, and a device controller.

In an exemplary embodiment, the server may store and manage the benchmark result, the anticipated performance information, the candidate node list, the benchmark configuration setting, a visualization element, block configuration information, block-wise performance information, layer and edge information in the block, and/or converting result information. For example, the server may include a storage unit (not illustrated) for storing the information. The storage unit may be included in the server, or may be present under the management of the server. As another example, the storage unit may also be present outside the server, and implemented in a form which is capable of communicating with the server. In this case, the storage unit may be managed and controlled by another external server different from the server. As another example, the storage unit may also be present outside the server, and implemented in a form which is capable of communicating with the server. In this case, the storage unit may be managed and controlled by another external server different from the server.

FIG. 2 illustrates an illustrative structure of an artificial intelligence based model according to an exemplary embodiment of the present disclosure.

Throughout the present disclosure, the model, the artificial intelligence model, the artificial intelligence based model, the operation model, and the neural network, the network function, and the neural network may be used interchangeably.

The artificial intelligence based model in the present disclosure may include models which are utilizable in various domains, such as a model for image processing such as object segmentation, object detection, and/or object classification, a model for text processing such as data prediction, text semantic inference and/or data classification, etc.

The neural network may be generally constituted by an aggregate of calculation units which are mutually connected to each other, which may be called “node.” The nodes may also be called neurons. The neural network is configured to include one or more nodes. The nodes (or neurons) constituting the neural networks may be mutually connected to each other by one or more links.

The node in the artificial intelligence based model may be used to mean a component that constitutes the neural network, and for example, the node in the neural network may correspond to the neuron.

In the neural network, one or more nodes connected through the link may relatively form a relationship between an input node and an output node. Concepts of the input node and the output node are relative and a predetermined node which has the relationship of the output node with respect to one node may have the relationship of the input node in the relationship with another node and vice versa. As described above, the relationship of the output node to the input node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable, and the weight may be varied by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form the input node and output node relationship in the neural network. A characteristic of the neural network may be determined according to the number of nodes, the number of links, correlations between the nodes and the links, and values of the weights granted to the respective links. For example, when the same number of nodes and links exist and two neural networks in which the weight values of the links are different from each other exist, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed from the initial input node up to the corresponding node. However, definition of the layer is predetermined for description and the order of the layer in the neural network may be defined by a method different from the aforementioned method. For example, the layers of the nodes may be defined by the distance from a final output node.

In an exemplary embodiment of the present disclosure, the set of the neurons or the nodes may be defined as the expression “layer.”

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean not the initial input node and the final output node but the nodes constituting the neural network.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

The deep neural network (DNN) may mean a neural network including a plurality of hidden layers other than the input layer and the output layer. When the deep neural network is used, the latent structures of data may be identified. That is, photographs, text, video, voice, protein sequence structure, genetic sequence structure, peptide sequence structure, and/or potential structure of music (e.g., what objects are in the photo, what is the content and emotions of the text, what contents and emotions of the voice, etc.) may be identified. The deep neural network may include convolutional neural network (CNN), recurrent neural network (RNN), auto encoder, generative adversarial networks (GAN), restricted Boltzmann machine (RBM), deep belief network (DBN), Q network, U network, Siamese network, etc. The description of the deep neural network described above is just an example and the present disclosure is not limited thereto.

The artificial intelligence based model of the present disclosure may be expressed by a network structure of an arbitrary structure described above, including the input layer, the hidden layer, and the output layer.

The neural network which may be used in a clustering model in the present disclosure may be learned in at least one scheme of supervised learning, unsupervised learning, semi supervised learning, or reinforcement learning. The learning of the neural network may be a process in which the neural network applies knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network ensures a certain level of performance quickly by using a high learning rate, thereby increasing efficiency and uses a low learning rate in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

According to an exemplary embodiment of the present disclosure, a computer readable medium is disclosed, which stores a data structure including the benchmark result and/or the artificial intelligence based model. The data structure may be stored in a storage unit (not illustrated) in the present disclosure, and executed by the processor 110 and transmitted and received by a communication unit (not illustrated).

The data structure may refer to the organization, management, and storage of data that enables efficient access to and modification of data. The data structure may refer to the organization of data for solving a specific problem (e.g., data search, data storage, data modification in the shortest time). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device may perform operations while using the resources of the computing device to a minimum. Specifically, the computing device may increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for learning the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for learning the neural network or a combination thereof. In addition to the above-described configurations, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be generally constituted by an aggregate of calculation units which are mutually connected to each other, which may be called “node.” The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include the weight of the neural network (in the present disclosure, the weight and the parameter may be used as the same meaning). In addition, the data structures, including the weight of the neural network, may be stored in the computer readable medium. The neural network may include a plurality of weights. The weight may be variable and the weight may be varied by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weight of the neural network may include a data structure including the weight which varies in the neural network learning process and/or the weight in which neural network learning is completed. Accordingly, the above-described weight and/or a combination of each weight are included in a data structure including a weight of a neural network. The data structure is just an example and the present disclosure is not limited thereto.

The data structure including the weight of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weight of the serialized neural network may be reconfigured in the same computing device or another computing device through deserialization. The data structure including the weight of the neural network is not limited to the serialization. Furthermore, the data structure including the weight of the neural network may include a data structure (for example, B-Tree, R-Tree, Trie, m-way search tree, AVL tree, and Red-Black Tree in a nonlinear data structure) to increase the efficiency of operation while using resources of the computing device to a minimum. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example, and the present disclosure is not limited thereto.

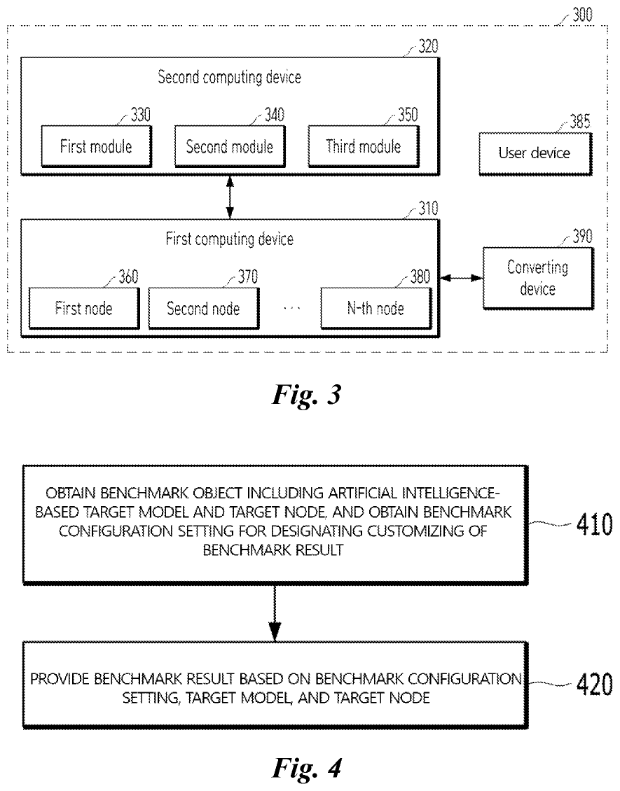

FIG. 3 is an exemplary schematic view for a system for providing a benchmark result according to an exemplary embodiment of the present disclosure.

In an exemplary embodiment, the system 300 may correspond to the computing device 100. In another exemplary embodiment, at least one of a first computing device 310, a second computing device 320, or a user device 385 may also correspond to the computing device 100.

In an exemplary embodiment, the first computing device 310 may include or manage a first node 360, a second node 370, . . . , an N-th node 380. As an example, the first computing device 310 may serve as the device farm that performs the benchmark for each of the plurality of nodes.

In an exemplary embodiment, the second computing device 320 may include a plurality of modules that performs different operations related to the artificial intelligence-based model. For example, the second computing device 320 may include a first module 330, a second module 340, and a third module 350. In an exemplary embodiment, the first module 330 may generate a learning model based on an input dataset. The second module 340 compresses the input model to generate a lightweight model. The third module 350 may generate download data for deploying the input model in at least one target node. In the example of FIG. 3, three modules are taken as an example, but it will be appreciated by those skilled in the art that various numbers of modules may be included in the second computing device 320 according to an implementation aspect.

In an exemplary embodiment, a plurality of modules 330, 340, and 350 may generate outputs of respective modules by utilizing a benchmark result by different schemes.

For example, the first module 330 may generate a learning model (or block) based on the input dataset. The first module may use the benchmark result for determining a target node which is to benchmark the learning model (or block). The first module 330 may use the benchmark result in order to confirm a performance when the learning model (or block) is executed at the target node. The first module 330 may use the benchmark result for generating the learning model (or block) or a re-learning model (or block). The first module 330 may use the benchmark result for determining the type of learning model or re-learning model corresponding to the dataset. The benchmark result may be used to evaluate the performance of the learning model (or block) output from the first module 330. The performance of the learning model (or block) output from the first module 330 may include a memory footprint, a latency, power consumption, and/or node information (an execution configuration of the node, a processor, and/or a RAM size). For example, the first module 330 uses a benchmark result including performance information corresponding to a plurality of layers (e.g., input layers) of a model to determine a size of input data of the model. As an example, the memory footprint may include the amount of main memory used or referenced during execution of a specific program (for example, while an inference operation is performed).

For example, the second module 340 compresses the input model (or block) to generate the lightweight model. The second module 340 may use the benchmark result for determining compression setting data for the input model (or block). For example, the second module 340 may determine whether to compress or optimize each of the plurality of layers of the model by using the benchmark result including the performance information for each of the plurality of layers of the model.

For example, the third module 350 may generate download data for deploying the input model (or block) in at least one target node. The third model 350 may use the benchmark result for generating the download data or converting data into a data type supported by the target node. The third module 350 may use the benchmark result for checking which degree of performance the input model (or block) shows in a node which has a specification which is similar to a specification of a node desired by the user as much as possible.

In an exemplary embodiment, the first computing device 310 and the second computing device 320 interacts with each other to provide the benchmark result to the user device 385. For example, the first computing device 310 may provide a benchmark result required for the operation of the second computing device 320 to the second computing device 320 in response to a request of the second computing device 320.

In an exemplary embodiment, in FIG. 3, the first computing device 310 is expressed as a separate entity outside the second computing device 320, but the first computing device 310 and the second computing device 320 may also operate as an integrated module according to an implementation aspect.

In an exemplary embodiment, the first computing device 310 may receive a query related to the benchmark from the second computing device 320, and receive a query related to the benchmark from other entities other than the second computing device 320, and may also receive a query related to the benchmark from the user device 385. As an example, the query related to the benchmark may include information on a target model to be benchmarked and a target node in which the benchmark is to be executed. As an example, the query related to the benchmark may include information on a specific area (e.g., a part of the model) in the target model to be benchmarked and the information on the target? node in which the benchmark is to be executed. As an example, the query related to the benchmark may include a benchmark configuration setting including various conditions and comparison options related to the benchmark.

A technique according to an exemplary embodiment of the present disclosure may allow the user to set the benchmark object for the area of the benchmark by the unit of a layer constituting the model or by the unit of a block corresponding to a group of layers rather than by the unit of the model to achieve a technical effect of being capable of solving more accurate and specific needs of the user.

The technique according to an exemplary embodiment of the present disclosure provides various types of benchmark configuration settings including a computing resource related condition for executing the benchmark and/or a comparison option for the benchmark result to provide a high utilization for the benchmark result to the user.

In an exemplary embodiment, the first computing device 310 may provide the benchmark result in response to the benchmark query. For example, the first computing device 310 may provide a benchmark result of the artificial intelligence-based model (e.g., a learning model or a compression model created by the user).

In an exemplary embodiment, the first computing device 310 may generate benchmark results corresponding to various types of benchmark queries. For example, the benchmark result may include different information according to the type of benchmark query, contents of the benchmark configuration setting, and/or information included in the benchmark query.

In an exemplary embodiment, the first computing device 310 may receive module identification information indicating which module among the plurality of modules of the second computing device 320 triggers the benchmark operation of the first computing device 310, and provides the benchmark result to the second computing device 320 based on the module identification information. The benchmark result provided to second computing device 320 may vary depending on the module identification information. For example, the first computing device 310 may provide performance information obtained for the entire input model to the second computing device 320 when the module identification information indicates the first module 330, and provide the performance information obtained for the entire input model to the second computing device 320 and/or provide performance information obtained by the unit of the block of the input model or performance information obtained by the unit of a partial area of the input model when the module identification information indicates the second module 340.

In an exemplary embodiment, the first computing device 310 may provide, to the second computing device 320, a benchmark result for determining a target node in which the learning model corresponding to the input dataset or the converted learning model is to be executed when the module identification information indicates the first module 330. The first computing device 310 may provide, to the second computing device 320, a benchmark result including compression setting data used for generating the lightweight model corresponding to the input model when the module identification information indicates the second module 340.

In an exemplary embodiment, the first computing device 310 may correspond to an entity that manages a plurality of nodes. The first computing device 310 may perform a benchmark for nodes included in a node list including a first node 360, a second node 370, . . . , an N-th node 380. Here, N may correspond to a natural number. For example, the first node 360 to the N-th node 380 may be included in a candidate node list which is under the management of the first computing device 310.

In FIG. 3, it is illustrated that the first node 360, the second node 370, . . . , the N-th node 380 are included in the first computing device 310, but the first node 360, the second node 370, . . . , the N-th node 380 are present outside the first computing device 310 according to an implementation aspect, and may interact with each other through communication with the first computing device 310.

In an exemplary embodiment, the first computing device 310 may generate a benchmark result for at least one node among the plurality of nodes in response to the benchmark query from the user device 385 and/or the benchmark query from the second computing device 320. For example, the benchmark query from the user device 385 may be input into the second computing device 320, and the benchmark query may also be transmitted to the first computing device 310 through the second computing device 320.

In an exemplary embodiment, the first computing device 310 interacts with the converting device 390 in response to the benchmark query from the user device 385 and/or the benchmark query from the second computing device 320 to generate the benchmark result for at least one node among the plurality of nodes. In an exemplary embodiment, the converting device 390 may correspond to an entity for converting the model. For example, the converting device 390 may convert the model included in the benchmark query into a model which is executable at the target node. For example, when the conversion for the model is included in the benchmark query, the converting device 390 may perform model conversion according to the benchmark query.

As illustrated in FIG. 3, the converting device 390 may be present as a separate entity from the first computing device 310 and the second computing device 320. As another example, the converting device 390 may also operate as an entity included in the first computing device 310 and/or the second computing device 320.

In an exemplary embodiment, the benchmark result may include a result of executing (e.g., inferring) the artificial intelligence-based model at the target node. As an example, the benchmark result may include a performance measurement result (e.g., performance information) which may be obtained from the target node when the artificial intelligence-based model is executed at the target node. As another example, the benchmark result may include a performance measurement result when the converted artificial intelligence-based model is executed at the target node.

In an exemplary embodiment, the benchmark result may be used for various purposes, and as various forms. For example, the benchmark result may be used for determining the target node in which the model is to be executed. For example, the benchmark result may be used for generating the candidate node list corresponding to the input model. For example, the benchmark result may be used for determining the size of the input data of the model. For example, the benchmark result may be used for determining a layer to be compressed or optimized in the model. For example, the benchmark result may be used for optimization or compression for the model. For example, the benchmark result and/or a prediction result may be used for deploying the model at the target node. For example, the benchmark result may be used for generating a benchmark prediction result corresponding to a subsequent benchmark query.

FIG. 4 illustratively illustrates a method for providing a benchmark result according to an exemplary embodiment of the present disclosure.

In an exemplary embodiment, the method illustrated in FIG. 4 may be performed by the computing device 100. As an example, the method illustrated in FIG. 4 may be performed by the first computing device 310. As another example, the method illustrated in FIG. 4 may be performed by the computing device 100 that encompasses the first computing device 310 and the second computing device 320.

Hereinbelow, an example in which steps of FIG. 4 are performed by the computing device 100 will be described in detail. It will be appreciated by those skilled in the art that some of the steps illustrated in FIG. 4 may be omitted or an additional step may be included according to the implementation aspect.

In an exemplary embodiment, the computing device 100 may obtain a benchmark object including an artificial intelligence-based target model and an artificial intelligence-based target node, and obtain a benchmark configuration setting for designating customizing of a benchmark result (410).

In an exemplary embodiment, the computing device 100 may receive a benchmark query of intending to benchmark a specific model. For example, the benchmark query may be obtained from an input from a user. For example, the benchmark query may include a model file which is modeled, and model type or model identification information to be benchmarked. As another example, the benchmark query may include the model file which is modeled, and model type or model identification information corresponding to the model file. As another example, the benchmark query may include the model file which is modeled, the model type or model identification information corresponding to the model file, and target model type or target model identification information to be benchmarked. As another example, the benchmark query may include information requesting the benchmark, and a candidate model list including models which are enabled to be benchmarked may be provided in response to the benchmark query. In response to the user input on the candidate model list, a target model may be determined.

In an exemplary embodiment, the benchmark query may further include information on a target node in which the benchmark for the target model is to be executed. The target node may be determined by user selection on a candidate node list including a plurality of candidate nodes. The target node may be determined by user selection on a candidate node list including candidate nodes which may support a framework of a target model.

In an exemplary embodiment, the benchmark query may include a benchmark configuration setting including various types of benchmark conditions and/or a comparison option of the benchmark result. For example, the benchmark configuration setting may include at least one of a resource condition for the target node, a first comparison option for a benchmark result for each of a plurality of layers constituting the target model, a second comparison option for a benchmark result of each of a plurality of nodes including the target node, a third comparison option for comparison benchmark results of a plurality of respective models including the target model at the target node, or target area information identifying a target area to be benchmarked in the target model.

In an exemplary embodiment, the resource condition for the target node may include a condition related to the use of a computing resource of an operation other than an inference operation of a target model on a target node or a condition related to the use of a computing resource of an application other than an inference application of the target model on the target node, when inference of the target model is executed at the target node. In response to a resource condition for the target node, the computing device 100 may obtain a benchmark result including performance information obtained by executing the target model at the target node by assuming a computing resource situation corresponding to the resource condition. For example, while other applications are being executed on the target node or another inference operation is being executed, when a resource condition corresponding to a situation in which there is a CPU share of 60% on the target node is included in the benchmark configuration setting, the computing device 100 executes the target model at the target node to obtain the benchmark result in a state in which it is assumed that the target node has the CPU share of 60%. As another example, the resource condition may include information assuming a situation in which it is slowest on the node. A benchmark result of comparing in which node among the plurality of nodes it may be slowest in a worst situation may be obtained through the resource condition.

In an exemplary embodiment, the resource condition for the target node may include a condition related to a share of the computing resource used on the target node when the inference of the target model is executed at the target node. As an example, the condition related to the use of the computing resource may include a share and/or a usage related to a CPU, a GPU, a RAM, and/or a network. As an example, the condition related to the use of the computing resource may further include a current power consumption.

In an exemplary embodiment, the resource condition for the target node may include information identifying the computing resource to be included in the benchmark result when the inference of the target model is executed at the target node. For example, the resource condition for the target node may identify which computing resource is to be included in the benchmark result. As a non-limited example, the computing resource may include a memory footprint, a CPU usage, a GPU usage, and/or power consumption.

In an exemplary embodiment, the benchmark configuration setting may include various types of comparison options. For example, the benchmark configuration setting may include an option for outputting performance information for the plurality of respective models in one node to be compared, an option of applying a plurality of configuration settings in one node, an option for outputting performance information obtained by executing one model in the plurality of nodes to be compared, an option of applying one configuration setting to the plurality of nodes, an option of outputting performance information by executing the plurality of models in the plurality of nodes to be compared, an option of applying the plurality of configuration settings to the plurality of nodes, and an option for outputting performance information for one node or the plurality of nodes to be compared by the unit of the layer of the model.

In an exemplary embodiment, the first comparison option may include an option for visually comparing the benchmark results for the plurality of respective layers in the target model at the target node. For example, the first comparison option may include an option for outputting performance information for benchmark results for a plurality of respective layers in one target model in one target node through a comparative type visual element. For example, the first comparison option may include an option for outputting performance information for benchmark results for a respective layers in plurality of target model in one target node through a comparative type visual element. The first comparison option may also be used jointly with the resource condition. In this case, performance information of layers may be visually comparatively output under a specific computing resource condition. In response to the first comparison option, the computing device 100 may output performance information corresponding to a plurality of layers constituting the artificial intelligence-based model, respectively by using the comparative type visual element. As an example, in response to the first comparison option, the computing device 100 may comparatively output a layer-wise inference time (e.g., latency) of a specific model.

In an exemplary embodiment, the second comparison option may include an option for visually comparing a benchmark result for a target model at each of a plurality of nodes including a target node, and a benchmark result for each of the plurality of layers in the target model at each of the plurality of nodes including the target node. For example, the second comparison option may include an option for comparing performance information for a specific model based on the plurality of nodes. As a result, the user may determine which node has an appropriate performance or which layer has an appropriate performance in various nodes (or various driving configurations) through the benchmark result. As another example, the second comparison option may include an option for outputting the performance information for the plurality of respective layers of the specific model by the unit of the node. In such an example, the node-wise or layer-wise performance information may be comparatively output.

In an exemplary embodiment, the benchmark configuration setting may include a third comparison option for visually comparing benchmark results for a plurality of respective models including the target model at the target node. For example, the computing device 100 may output performance information when the plurality of respective models including the target model are executed in the plurality of respective nodes including the target node in a comparative type in response to a benchmark query including the third comparison option.

In an exemplary embodiment, the computing device 100 may provide the benchmark result based on the benchmark configuration setting, the target model, and the target node (420).

In an exemplary embodiment, the computing device 100 may generate a benchmark result including performance information obtained or measured by executing the target model at the target node based on the benchmark configuration setting.

In an exemplary embodiment, the computing device 100 may determine elements to be included in the performance information based on the benchmark configuration setting. In an exemplary embodiment, the computing device 100 may judge details of the benchmark configuration setting included in the benchmark query by parsing the benchmark query.

For example, when the benchmark configuration setting includes the option for comparing the performance information for the plurality of respective layers in the target model, the computing device 100 may obtain performance information corresponding to a plurality of respective layers constituting a model, and output the performance information corresponding to the plurality of respective layers in a comparative type (e.g., an N-dimensional graph type, where N is a natural number). For example, the performance information corresponding to the plurality of respective layers may include the numbers of calls for the plurality of respective layers and latencies for the plurality of respective layers. As an example, the number of calls may mean the number of times of calling a specific layer in a process related to inference during a period (e.g., an operation period) from the start of the inference operation to the end of the inference operation. As an example, the latency may mean an operation period (e.g., an inference time period of a single layer) corresponding to a specific layer during the operation period related to the inference.

For example, when the benchmark configuration setting includes the option for comparing the performance information for the plurality of respective layers in the target model, the computing device 100 may obtain a benchmark result that distinguishes and displays layers which are able to be optimized and layers which are not able to be optimized with respect to the plurality of respective layers constituting the artificial intelligence-based model. The computing device 100 may distinguish the layers which are able to be optimized and the layers which are not able to be optimized with respect to the plurality of respective layers. For example, a first layer that performs a convolutional operation in the model may be classified into the layer which is able to be optimized and a second layer that performs a sigmoid operation in the model may be classified into the layer which is not able to be optimized. The computing device 100 may predetermine whether the layer is able to be optimized based on identification information of the layer. Information regarding whether each predetermined layer is able to be optimized may be stored and managed in the storage unit of the computing device 100.

In an exemplary embodiment, the information regarding whether each layer is able to be optimized may be used for judging whether each layer is compressed or whether each layer is lightweight. As an example, when the first layer may be determined as the layer which is not able to be optimized, and the second layer is the layer which is able to be optimized and has a latency of 30 ms, and a third layer is the layer which is able to be optimized and has a latency of 10 ms, the second layer may be determined as an optimization, lightweight, or compression target.

In an exemplary embodiment, the computing device 100 may obtain information on a target model to be benchmarked by parsing the benchmark query. The information on the target model may include, for example, identification information of a model, a name of a model file, a software version, a framework, a size of the model, an input shape of the model, a batch size, and/or the number of channels.

In an exemplary embodiment, the computing device 100 may obtain information on a target node in which benchmarking is to be executed by parsing the benchmark query. As an example, the benchmark query may include the information on the target model to be benchmarked and the information on the target node in which the benchmarking is to be executed.

In an exemplary embodiment, a user input for designating a benchmark object may include, for example, information on a model and a node for which anticipated performance information is to be obtained. In an exemplary embodiment, the user input for designating the benchmark object may include, for example, information on a model and a node for which performance information is to be measured.

In an additional exemplary embodiment, the computing device 100 may provide information selecting a target node in which the benchmarking of the target model is to be executed in response to the benchmark query. As an example, the target node may refer to a device to be executed for measuring a performance of the model. As another example, the target node may refer to a device which becomes a target of which anticipated performance is to be measured.

In an exemplary embodiment, the performance information or the anticipated performance information corresponding to the target node may be obtained based on a pre-stored benchmark result for the target node. As an example, the information on the target node may include identification information of the target node, a software version related to the target node, software information which is supportable at the target node, and/or an output data type related to the target node. As a non-limited example, the identification information of the target node may be, for example, Jetson Nano, Jetson Xavier NX, Jetson TX2, Jetson AGX Xavier, Jetson AGX Orin, GPU AWS-T4, Xeon-W-2223, Raspberry Pi Zero, Raspberry Pi 2W, Raspberry Pi 3B+, Raspberry Pi Zero 4B, etc. Information selecting the target node may include, for example, a candidate node list including a plurality of candidate nodes. As an example, the candidate node list may include candidate nodes which may support a model type (e.g., a model framework) corresponding to the benchmark query.

In an exemplary embodiment, the benchmark configuration setting may include target area information identifying a target area to be benchmarked in the target model. The target area information may include a part of the target model. As a result, the computing device 100 may obtain a benchmark result limited to the target area corresponding to a part of the target model. As an example, the benchmark result may include performance information or anticipated performance information corresponding to a target area identified when the benchmarking is performed at the target node.

In an exemplary embodiment, the benchmark query may include model type information. The model type information may be obtained by the user input.

In an additional exemplary embodiment, the model type information may be obtained as the benchmark query is parsed. As an example, the benchmark query may include the model file, and the computing device 100 may extract model type information (e.g., the framework of the model) corresponding to the model file by parsing the model file.

In the present disclosure, the model type information may be used interchangeably with the model identification information. The model type information may include any type of information identifying the input artificial intelligence-based model. For example, the model type information may include information indicating an execution configuration of the model, such as Tflite, Onnxruntime, OpenVINO, and Tensorrt. For example, the model type information may also include library information or software version information for the execution configuration of the model. In such an example, the model type information may be expressed as Python 3.7.3 and pillow 5.4.1 of Tflite.

In the present disclosure, the target model type information may be used interchangeably with the target model identification information. In an exemplary embodiment, the target model type information to be benchmarked may include any type of information identifying the artificial intelligence-based model for performing the benchmarking. As an example, the model type information (e.g., a model prepared by the user) included in the user input and the model type information for which benchmarking is to be performed may be different from each other. In such an example, the benchmark query may include information on the model prepared by the user (e.g., a prepared model file) and target model type information to be actually benchmarked.

In an exemplary embodiment, the computing device 100 may extract corresponding model type information and/or model target type information from the input artificial intelligence-based model. The computing device 100 may obtain or extract execution configuration and/or library information of the model by parsing the input artificial intelligence-based model (e.g., the model file). For example, the computing device 100 may generate benchmark result information for the target node based on the obtained information on the model.

In an exemplary embodiment, the computing device 100 may also determine whether to convert the model by comparing the extracted model type information and the input target model type information. In an example, the target model type information may be different from the model type information of the input artificial intelligence-based model. In this case, the computing device 100 may obtain a converting result in which the input artificial intelligence-based model is converted to have the target model type information. The target model type information and the model type information of the input model being different may mean information on the execution configuration of the model and/or the library information for the execution configuration being different. As an example, converting may include replacing an operator included in the input model to correspond to the target model type information. As an example, converting may include changing the library information or software version of the input model to correspond to the target model type information. As an example, converting may include changing the execution configuration of the input model to an execution configuration corresponding to the target model type information. In such examples, the computing device 100 may determine whether to convert at least a part of the input model by comparing the model type information and the target model type information. For example, the computing device 100 may determine not converting a part of the input model when the model type information of the input model coincides with the target model type information and determine converting a part of the input model when the model type information of the input model is different from the target model type information.

In an additional exemplary embodiment, the computing device 100 may also determine whether to convert the model based on information related to the model and information related to the target node. For example, the computing device 100 may determine whether to convert the model based on whether the model is supported at the target node. For example, the model may not be supported at the target node. In this case, the computing device 100 may determine converting the model or determine converting at least some of layers included in the determined model. As another example, the computing device 100 may also determine that converting the determined model is required or determine changing the selected node to another node when the determined model is not supported at the target node.

In an exemplary embodiment, the computing device 100 may determine at least one target block to be used for obtaining a benchmark result corresponding to the benchmark query among a plurality of prestored blocks based on the benchmark query. In an exemplary embodiment, the computing device 100 may obtain the benchmark result corresponding to the benchmark query by using the benchmark result related to at least one target block. Here, the benchmark result may include the anticipated performance information.

In the present disclosure, the block may refer to a group of one or more layers constituting the model. For example, it is assumed that a specific model is constituted by a first layer that performs a first convolutional operation, a second layer that performs a first sigmoid operation, a third layer that performs a second convolutional operation, and a fourth layer that performs a second sigmoid operation. Under the assumption, the block may correspond to any type of group which may be made by the first layer, the second layer, the third layer, and the fourth layer. As an example, the block may be constituted by one layer among the first layer, the second layer, the third layer, and the fourth layer. As another example, the block may be constituted by a combination of two layers among the first layer, the second layer, the third layer, and the fourth layer. As another example, the block may be constituted by a combination of three layers among the first layer, the second layer, the third layer, and the fourth layer. As another example, the block may be constituted by the first layer, the second layer, the third layer, and the fourth layer. As an example, the block may correspond to subsets which are generatable from a plurality of layers. In such examples, when the block includes the plurality of layers, the block may include layers and an edge connecting the layers.

In the present disclosure, the target block may correspond to a block to be used for generating the anticipated performance information among the plurality of prestored blocks. For example, the computing device 100 may generate a benchmark result including anticipated performance information corresponding to the benchmark query based on performance information allocated to the target block and/or performance information allocated to respective sub blocks included in the target block.

In an exemplary embodiment, the benchmark query may identify the target area in the target model to be benchmarked. The benchmark query may include a range set in a specific model. As an example, the benchmark query may include an input of selecting an area including specific layers in a specific model. The target block corresponding to the benchmark query may be determined. The benchmark result may be generated based on the performance information allocated to the target block. The benchmark result may include anticipated performance information corresponding to the identified target area when the benchmarking is performed at the target node.

In an exemplary embodiment, the benchmark query may identify a start layer and an end layer in the target model to be benchmarked. For example, the benchmark query may include a range from the start layer to the end layer to be benchmarked in a specific model. The target block corresponding to the benchmark query may be determined. The benchmark result may be generated based on the performance information allocated to the target block. In such an example, the benchmark result may include anticipated performance information corresponding to a target area defined by the identified start layer and the identified end layer when the benchmarking is performed at the target node.

In an exemplary embodiment, the benchmark query may include a layer identifier and an edge identifier in the target model to be benchmarked. For example, the benchmark query may include information identifying one or more layers which intend to perform benchmarking in the specific model. For example, the benchmark query may include information identifying a connection relation between the layers which intend to perform benchmarking in the specific model. The target block corresponding to the benchmark query may be determined. The benchmark result may be generated based on the performance information allocated to the target block. In such examples, the benchmark result may include anticipated performance information corresponding to a target area defined by the identified layer identifier and the identified edge identifier when the benchmarking is performed at the target node.

As described above, since the technique according to an exemplary embodiment of the present disclosure may provide the benchmark result by the unit of the model, and may provide the benchmark result by the unit of a specific area selected by the user in the model, a technical effect that more specific and efficient information may be provided to the user may be achieved. Additionally, the technique according to an exemplary embodiment of the present disclosure may provide more accurate information determining which area or which layer performs compression in a specific model to increase compression efficiency.

In the present disclosure, the anticipated performance information may mean anticipated information related to a model or layer-wise performance for each of target nodes, which is measured in advance. As a non-limited example, the anticipated performance information may include anticipated latency information. In such an example, the anticipated performance information may be generated for each block. For example, the anticipated performance information may be generated for each block, for each layer, and/or for each node.

In an exemplary embodiment, the computing device 100 may determine a query layer and a query edge included in the benchmark query, determine a target layer corresponding to the query node and a target edge corresponding to the query edge, and determine a block including the target layer and the target edge among a plurality of prestored blocks as a target block to be used for obtaining a benchmark result corresponding to the benchmark query.

In an exemplary embodiment, the query layer and the query edge may be generated from information included in the benchmark query. For example, the benchmark query may include information on a combination and a configuration constituted by a layer and an edge to be benchmarked. The computing device 100 may determine ranges of layers to be benchmarked and/or a connection relationship between the layers based on the information included in the benchmark query. The layers and the edges constituting the range to be benchmarked may be referred to as the query layer and the query edge.

In an exemplary embodiment, the target layer and the target edge may correspond to the layer and the edge included in the target block. The target block including the target layer the target edge among the plurality of prestored blocks may be determined based on the configuration of the query layer and the query edge. For example, identification information of the layer included in the benchmark query may be used for determining the query layer, and the connection relationship between the layers included in the benchmark query may be used for determining the query edge. Based on the performance information allocated to the target block constituted by the target layer and the target edge or the performance information allocated to the sub block of the target block, a benchmark result corresponding to the target layer and the target edge (i.e., corresponding to the benchmark query) may be generated.

In an exemplary embodiment, the computing device 100 determines a similarity with the query layer and the query edge included in the benchmark query with respect to each of the plurality of prestored blocks, and assigns a priority for the plurality of prestored blocks based on the similarity to determine at least one target block to be used for obtaining the benchmark result corresponding to the benchmark query. For example, the identification information of the layer(s) to be benchmarked and the connection relationship between the layers may be determined from the benchmark query, and the query layer and the query edge may be determined based on the identification information and the connection relationship. The computing device 100 may determine similarities between the query layer and the query edge, and a plurality of predetermined blocks. For example, the similarity may be determined at least partially based on an attribute of the layer and a connection relationship between layers. For example, the computing device 100 may determine a similarity of each of the plurality of prestored blocks with the benchmark query, based on whether there being a layer having attribute information corresponding to attribute information of the query layer, whether there being a layer having identification information corresponding to the identification information of the query layer, whether there being a layer capable of replacing a function of the layer according to the identification information or the attribute information of the query layer, whether there being layers of a number corresponding to the number of query layers, and/or whether there being a connection relationship corresponding to a connection relationship between the query layer and the query edge. The similarity may be expressed in a form of a quantitative score or as a vectorized form in a vector space. For example, the computing device 100 may assign the priority for the plurality of blocks in an order of a high similarity. As an example, a candidate list of target blocks may be provided in the order of the high similarity. As another example, blocks in which the similarity exceeds a predetermined threshold similarity may be provided as the candidate list of the target blocks. As another example, a predetermined number of blocks may be provided as the target blocks in the order of the high similarity. In an exemplary embodiment, the target block corresponding to the benchmark query may be determined based on user selection on the candidate list of the target blocks or an additional algorithm of the computing device 100.

In an exemplary embodiment, the computing device 100 may determine whether a configuration of the layer and the edge corresponding to the configuration of the query layer and the query edge included in the benchmark query being present in one block among the plurality of prestored blocks, and determine a block including the corresponding configuration of the layer and the edge as the target block to be used for obtaining the benchmark result corresponding to the benchmark query when the configuration of the layer and the edge corresponding to the configuration of the query layer and the query edge included in the benchmark query is present in one block among the plurality of prestored blocks.

In an exemplary embodiment, the computing device 100 may determine a combination of two or more blocks for generating the configuration corresponding to the configuration of the query layer and the query edge among the plurality of prestored blocks when the configuration of the layer and the edge corresponding to the configuration of the query layer and the query edge included in the benchmark query is not present in one block among the plurality of prestored blocks. Likewise, the technique according to an exemplary embodiment of the present disclosure may also determine the combination of two or more blocks as the target block. For example, it is assumed that the configuration of the query layer and the query edge corresponds to a serial connection of layer A, layer B, layer C, and layer D, and the plurality of prestored blocks includes a first block representing a connection of layer A and layer B and a second block representing a connection of layer C and layer D. Under the assumption, since one block corresponding to the benchmark query is not present, the computing device 100 may determine a combination of the first block and the second block as the target block. In such an example, the computing device 100 combines performance information allocated to two or more determined blocks, respectively to obtain the benchmark result corresponding to the benchmark query. For example, the computing device 100 combines (e.g., aggregates) the performance information allocated to the first block and the performance information allocated to the second block to generate the benchmark result corresponding to the benchmark query.

In an exemplary embodiment, the computing device 100 may determine a block including a target layer having an attribute which is mutually replaceable with the attribute of the query layer as the target block to be used for obtaining a benchmark prediction result corresponding to the benchmark query among the plurality of prestored blocks when the configuration of the layer and the edge corresponding to the configuration of the query layer and the query edge included in the benchmark query is not present in the plurality of prestored blocks. In an exemplary embodiment, the target layer having the attribute which is mutually replaceable with the attribute of the query layer among the plurality of prestored blocks may correspond to a layer having data with a shape which is quantitatively replaceable with a shape of data of the query layer. The computing device 100 determines, based on a quantitative difference value between the attributes of the target layer and the query layer, a replacement value between the target layer in the target block, and the query layer, and applies the replacement value to the benchmark result allocated to the target block to obtain the benchmark result corresponding to the benchmark query. As an example, the replacement value may include a difference value or a ratio value between a quantitative size value corresponding to the shape of the data of the query layer and a size value corresponding to the shape of the data of the target layer. For example, it may be determined that the query layer included in the benchmark query uses data having a shape or a size of 64×3×6×6 as input data through the attribute of the query layer. In this case, the computing device 100 may identify a target layer having an input attribute having a shape or a size which is replaceable with the input data of the query layer. For example, the computing device 100 may determine a target layer having an input attribute with a shape or a size of 32×3×6×6 as a target layer having an attribute which is mutually replaceable with the attribute of the query layer. The block including the target layer may be determined as the target block. In such an example, the computing device 100 may generate the benchmark result corresponding to the benchmark query based on a quantitative difference or a quantitative relationship between the attribute of the query layer and the attribute of the target layer. For example, it can be seen that the quantitative difference in attribute (e.g., an input attribute or a size of the input data) between the query layer and the target layer is doubled. In such an example, by using a scheme of multiplying the performance information (e.g., a latency of 15 ms) allocated to the target layer or allocated to the target block by 2, a latency of 30 ms may be generated as the benchmark result corresponding to the benchmark query.

In an exemplary embodiment, each of the plurality of prestored blocks may include at least one sub block. For example, the sub blocks in one block are present as sub blocks of a number corresponding to the number of selectable cases for N layers included in one block or the number of combinationable cases, and the N may correspond to a predetermined natural number. For example, the sub block in one block may have, when layers included in one block is set as a universal set, the number of cases corresponding to sub sets of the universal set. In an exemplary embodiment, a benchmark result corresponding to each of prestored blocks and/or prestored sub blocks may be obtain through pre-measurement, and the benchmark result may be mapped to each of the prestored blocks and/or the prestored sub blocks.

In the present disclosure the benchmark result for the benchmark query may be obtained based on various algorithms using the target block.

In an exemplary embodiment, the computing device 100 may determine whether a block having a configuration which is the same as the configuration constituted by the layer and the edge included in the benchmark query among a plurality of blocks is present. When the corresponding block is present, the computing device 100 may use a benchmark result pre-measured for the determined block for generating a benchmark result corresponding to the benchmark query. For example, the computing device 100 may confirm whether the block having the configuration which is the same as the configuration of the benchmark query is present when receiving a benchmark query in which each of layer A, layer B, layer C, and layer D is connected to one edge in series. When there is the block having the configuration in which each of layer A, layer B, layer C. and layer D is connected to one edge in series, the computing device 100 may use performance information pre-measured for the corresponding block as the benchmark result for the benchmark query.

In an exemplary embodiment, the computing device 100 may also store a layer-wise benchmark result in the block and an edge-wise benchmark result in the block. In such an exemplary embodiment, the computing device 100 may obtain an identifier of each of the layers included in the benchmark query, and obtain the benchmark result for the layer in the block prestored, which corresponds to the obtained identifier of the layer. Further, the computing device 100 may obtain an identifier of each of the edges included in the benchmark query, and obtain the benchmark result for the edge in the block prestored, which corresponds to the obtained identifier of the edge. By such a scheme, the computing device 100 may generate the benchmark result corresponding to the benchmark query by a scheme of dividing the benchmark query into the layer and the edge, and combining a prestored benchmark result corresponding to the divided layer and a prestored benchmark result corresponding to the divided edge. For example, it is assumed that the benchmark query includes layer A, layer B, layer C, a first edge connecting layer A and layer B, and a second edge connecting layer A and layer C. Under the assumption, the computing device 100 may generate the benchmark result for the benchmark query by a scheme of combining benchmark result A pre-measured for layer A, benchmark result B pre-measured for layer B, benchmark result C pre-measured for layer C, benchmark result D pre-measured for the first edge connecting layer A and layer B, and benchmark result E pre-measured for the second edge connecting layer A and layer C. In such an example, the computing device 100 may measure the benchmark result by the unit of the layer and by the unit of the edge, and use a measured result for responding to a subsequent query. In such an example, the block may correspond to the layer and/or the edge.

In an exemplary embodiment, the computing device 100 may pre-measure a benchmark result for each of sub sets of the prestored block. The pre-measured benchmark result may be made into a database. The computing device 100 may generate the block constituted by layer A, layer B, layer C, the first edge connecting layer A and layer B, and the second edge connecting layer B and layer C. The computing device 100 may measure the benchmark result corresponding to the block by executing the block in various devices. Further, the computing device 100 may measure the benchmark result corresponding to each of the sub blocks corresponding to the sub sets of the block. For example, the computing device 100 executes layer A, layer B, layer C, a combination of layer A and layer B, a combination of layer B and layer C, a combination of layer A and layer C, and a combination of layers A, B, and C constituting one block in various nodes, respectively to measure a latency measured during a benchmarking process for each of the sub blocks. The measured latency may be made into the database. In such a situation, the computing device 100 may use a latency (i.e., the pre-measured latency corresponding to the combination of layer B and layer C) corresponding to the sub block of the prestored block as the benchmark prediction result corresponding to the benchmark query in response to reception of the benchmark query constituted by layer B and layer C. As a non-limited example, such an exemplary embodiment may be utilized when the block corresponding to the benchmark query is not present.

In an exemplary embodiment, the computing device 100 may generate the benchmark prediction result through the combination of the pre-stored block or the combination of the pre-stored sub blocks. For example, the computing device 100 may generate the benchmark prediction result corresponding to the benchmark query by a scheme of combining (e.g., aggregating) a first benchmark result allocated to a first block constituted by layer A and layer B and a second benchmark result allocated to a second block constituted by layer C and layer D in response to reception of the benchmark query constituted by layer A, layer B, layer C, and layer D.

In an exemplary embodiment, the computing device 100 may generate the benchmark result by a scheme of applying a mathematical operation for the benchmark result corresponding to the pre-stored block or the pre-stored sub block. When the layer and/or the edge corresponding to the benchmark query are/is not present in the pre-stored block or sub block, the computing device 100 may determine a layer and/or an edge which is replaceable with the layer and/or the edge as the target layer and/or the target edge. In an exemplary embodiment, when there is no pre-stored layer having a kernel size which is the same as a kernel size of the layer included in the benchmark query, the computing device 100 may determine a first layer having a most similar kernel size as the layer included in the benchmark query as the target layer. In an exemplary embodiment, when there is no pre-stored layer having the same kernel size as the layer included in the benchmark query, the computing device 100 may determine a second layer having the same kernel size as the layer included in the benchmark query as the target layer among the pre-stored layers when a mathematical operation (e.g., multiplication, division, square, etc.) is applied. As a non-limited example, although an expression of the sub block as a sub concept of the block is used for convenience of description, it will be apparent to those skilled in the art that the sub block may replace a concept of the block according to an implementation aspect.

In an exemplary embodiment, the computing device 100 may also generate the benchmark result corresponding to the benchmark query through the combination of various algorithms.

In an exemplary embodiment, the benchmark result may be generated by the computing device 100 or generated by another server which is under the management of the computing device 100.

In an exemplary embodiment, the benchmark result may include the performance information at the target node of the target model.

In an exemplary embodiment, the benchmark result may include time information including preprocessing time information required for preprocessing inference of the target model at the target node or inference time information required for inferring the target model at the target node. In an exemplary embodiment, the benchmark result may include memory usage information including preprocessing memory usage information required for preprocessing inference of the target model at the target node or inference memory usage information required for inferring the target model at the target node.

In an exemplary embodiment, the benchmark result may include memory footprint information required for executing the target model at the target node, latency information required for executing the target model at the target node, and/or power consumption information required for executing the target model at the target node.

In an exemplary embodiment, the benchmark result may vary depending on what module of another computing device which triggers or requests the benchmark operation of the computing device 100 is. For example, when the module that triggers the benchmark operation of the computing device 100 is a first module, the computing device 100 may provide performance information obtained for the entire input model, and when the module that triggers the benchmark operation of the computing device 100 is a second module, the computing device 100 may additionally provide performance information a partial model unit (e.g., a block unit which is a lower component of the model) of the input model jointly with providing the performance information obtained for the entire input model. As another example, when module that triggers the benchmark operation of the computing device 100 is the first module, the computing device 100 may provide a benchmark result for determining a target node in which a learning model corresponding to an input dataset or a converted learning model is to be executed, and when the module that triggers the benchmark operation of the computing device 100 is the second module, the computing device 100 may provide a benchmark result including compression setting data used for generating the lightweight model corresponding to the input model.

In an exemplary embodiment, the benchmark result may include preprocessing time information required for preprocessing inference of the target model in at least one target node, inference time information required for inferring the target model in at least one target node, preprocessing memory usage information used for preprocessing the inference of the target model in at least one target node, inference memory usage information used for inferring the target model in at least one target node, quantitative information related to an inference time, which is obtained as the target model is repeatedly inferred at a predetermined number of times in at least one target node, and/or quantitative information related to memory use for each of the NPU, the CPU, and the GPU, which is obtained as the target model is inferred in at least one target node.

In an exemplary embodiment, the preprocessing time information may include time information required for preprocessing before the inference operation is performed such as calling the model. Additionally, the preprocessing time information may also include quantitative information (e.g., a minimum value, a maximum value, and/or an average value of a time required for pre-inference) related to a time required for the pre-inference when the pre-inference is repeated at a predetermined number of times for activation of the GPU, etc., before measuring a value for inference.

In an exemplary embodiment, the inference time information as time information required for during an inference process may be used to encompass minimum time information, maximum time information, average time information, and/or median time information among the inference time information among time information required for an initial inference operation for the model when the mode is inferred repeatedly at the predetermined number of times, for example. Additionally, for example, in a situation in which the CPU receives and processes an operation which may not be processed by the NPU, the NPU becomes an idle state, and the inference time information may include a first cycle value when the NPU becomes the idle state. Additionally, the inference time information may also include a second cycle value when the NPU performs inference and/or a third cycle value obtained by aggregating the first cycle value and the second cycle value.

In an exemplary embodiment, benchmark result information may also include total time information obtained by aggregating the preprocessing memory usage information and the quantitative information related to the inference time.

In an exemplary embodiment, the benchmark result information may additionally include a RAM usage, a ROM usage, a total memory usage, and/or a quantitative value for an SRAM area used by the NPU.

In an exemplary embodiment, the computing device 100 may align a plurality of benchmark results based on the latency when the plurality of benchmark results is generated as multiple nodes are selected as the target node and/or multiple models or layers are selected. For example, the benchmark results may be aligned and output in an order of a smallest latency. In an additional exemplary embodiment, when there are benchmark results corresponding to a plurality of nodes in which the latency is within or is the same as a predetermined similar range, the benchmark results may be aligned additionally based on a memory usage and/or a CPU share. The alignment for the benchmark results may include a feature related to alignment on the candidate node list.

In an exemplary embodiment, the benchmark result may include various types of comparison information.

In an exemplary embodiment, the benchmark result may include at least one of a first result that comparatively displays a maximum inference latency obtained by executing the target model by assuming a computing resource situation which may be slowest in the plurality of respective nodes including the target node, a second result that comparatively displays an average inference latency when the target model is executed at a plurality of numbers of times in a plurality of respective nodes including the target node, and a third result that comparatively displays an interference latency for each of the plurality of layers in the target model in the plurality of respective nodes including the target node. In an additional exemplary embodiment, the benchmark result may also comparatively display a minimum inference latency obtained by executing the target model by assuming a computing resource situation which may be fastest in the plurality of respective nodes including the target node. In an additional exemplary embodiment, the benchmark result may also comparatively display a latency required for an initial inference among a plurality of inferences. In an additional exemplary embodiment, the benchmark result may also comparatively display a latency required during a warm-up process of the inference. In an additional exemplary embodiment, the benchmark result may also comparatively display a median latency for the plurality of inferences.

In an exemplary embodiment, the benchmark result may include a fourth result that comparatively displays a processor margin value in which another operation or another application may be driven in the process of inferring the target model at the target node. For example, the processor margin value may include an available margin for the CPU and/or an available margin for the GPU. The benchmark result may include a fifth result that comparatively displays a memory margin value in which another operation or another application may be driven in the process of inferring the target model at the target node. For example, the memory margin value may include an available margin for a CPU memory and/or an available margin for a GPU memory.

In an exemplary embodiment, the computing device 100 may provide, to the first module, a benchmark result including performance information corresponding to an input layer among a plurality of layers of the model so as for the first module that trains the target model to determine a size of input data of the target model. In an exemplary embodiment, the computing device 100 may provide, to the second module, a benchmark result including performance information for each of the plurality of layers of the target model so as for the second module that generates a lightweight target model by compressing the target model to determine whether to compress each of the plurality of layers of the target models. By the above-described scheme, the computing device 100 interacts the module that trains the model and/or the module that compresses the model to maximize a utilization for the benchmark result.

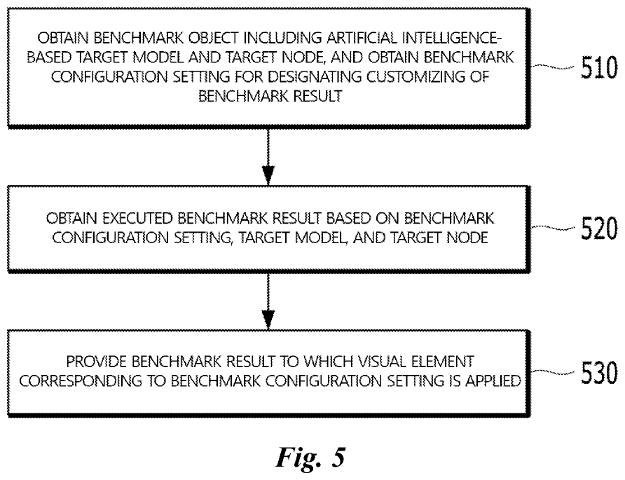

FIG. 5 illustratively illustrates a method for providing a benchmark result according to an exemplary embodiment of the present disclosure.

In an exemplary embodiment, the computing device 100 may obtain a benchmark object including an artificial intelligence-based target model and an artificial intelligence-based target node, and obtain a benchmark configuration setting for designating customizing of a benchmark result (510). In an exemplary embodiment, the computing device 100 may obtain a benchmark result executed based on a benchmark configuration setting, a target model, and a target node (520). A detailed description of steps 510 and 520 in FIG. 5 will be replaced with a description related to steps 410 and 420 in FIG. 4.

In an exemplary embodiment, the computing device 100 may provide a benchmark result to which a visual element corresponding to the benchmark configuration setting is applied (530).

In an exemplary embodiment, the visual element may include any type of visual element provided on a user interface. For example, the visual element may include elements included in a graph and/or elements included in a table.

In an exemplary embodiment, the computing device 100 may determine a visual element to be included in the benchmark result by parsing the benchmark configuration setting. The determined visual element may be combined with performance information obtained by performing benchmarking, and output on the user interface.

In an exemplary embodiment, the computing device 100 may determine the visual element to be included in the benchmark result based on the benchmark configuration setting, obtain the performance information to be included in the benchmark result based on the target model and the target node, and provide the benchmark result in which the performance information is displayed according to the visual element. For example, the visual element may include information identifying a plurality of respective axes included in the benchmark result, and information identifying a form of the graph included in the benchmark result.

In an exemplary embodiment, the computing device 100 may determine a visual element for efficiently outputting the benchmark configuration setting by parsing the benchmark configuration setting. For example, when the benchmark configuration setting includes information related to latencies for a plurality of respective nodes and a plurality of respective layers, the computing device 100 may determine a visual element (e.g., a bar graph) capable of efficiently comparing the plurality of respective nodes and the plurality of respective layers, and determine a visual element (e.g., a 3D bar graph) capable of efficiently comparing the plurality of nodes, the plurality of layers, and/or the latency information.

In an additional exemplary embodiment, the computing device 100 may obtain importance level information corresponding to the visual elements to be included in the benchmark result. As an example, the importance level information may include information representing a priority of the visual element output as the benchmark result, which is input from a user. As an example, the importance level information may include the information representing the priority of the visual element output as the benchmark result according to a predetermined rule-based algorithm. A layout and contents of the user interface including the benchmark result may be determined based on the importance level information and/or the benchmark configuration setting.

In an additional exemplary embodiment, the computing device 100 may provide a candidate node list including candidate nodes recommended to determine the target node by using a benchmark result pre-obtained for each of the nodes based on the importance level information. The candidate nodes on the candidate node list may be provided to a user interface of a form for recommending the target node to the user. In response to a user input on the candidate node list, the target node may be determined.

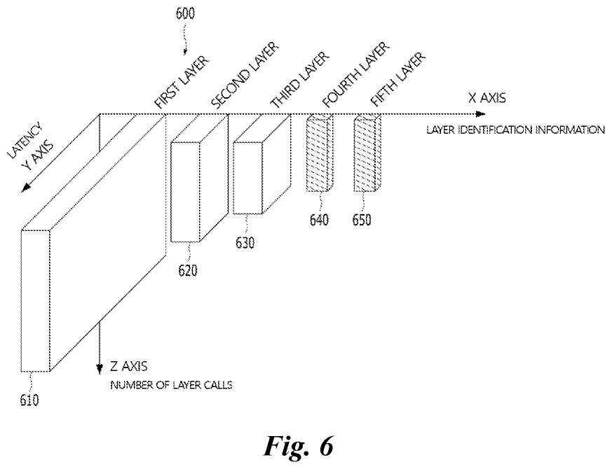

FIG. 6 illustratively illustrates a benchmark result 600 to which a visual element is applied according to an exemplary embodiment of the present disclosure.

In an exemplary embodiment, when the benchmark configuration setting includes an option of comparing performances of the plurality of layers constituting the target model, the computing device 100 may generate a benchmark result 600 illustrated in FIG. 6.

As illustrated in FIG. 6, the benchmark result 600 may include a 3D graph constituted by X, Y, and Z axes. Here, the X axis may indicate layer identification information, the Y axis may indicate first performance information (e.g., latency) for each of the layers, and the Z axis may indicate second performance information (e.g., the number of calls during an inference process) for each of the layers. The latency corresponding to the first performance information may represent a total inference time according to a layer type. The number of calls corresponding to the second performance information may represent a total number of calls according to the layer type. Here, the total inference time and the total number of calls may be used as a meaning that encompasses measurement information during a single inference process or measurement information aggregated in a plurality of inferences.

As an example, the first performance information and the second performance information may include an actually measured result in response to reception of a benchmark query corresponding to the benchmark result 600. As another example, the first performance information and the second performance information may include anticipated performance information generated based on pre-measured performance information before receiving the benchmark query corresponding to the benchmark result 600.

In an exemplary embodiment, the target model may be constituted by a first layer, a second layer, a third layer, a fourth layer, and a fifth layer. As illustrated on the user interface of FIG. 6, a group of the first layer, the second layer, and the third layer and a group of the fourth layer and the fifth layer may be displayed to be visually distinguished from each other. The group of the first layer, the second layer and the third layer may represent a layer which is able to be optimized, and the group of the fourth layer and the fifth layer may represent a layer which is not able to be optimized. A quantitative value of the latency and a quantitative value of the number of layer calls may be intuitively confirmed through the size of the graph on the benchmark result 600. As described above, the benchmark result 600 may be used for determining a compression technique suitable for each type of layer. For example, a first compression technique may be used for the first layer based on performance information 610 corresponding to the first layer, and a second compression technique different from the first compression technique may be used for the second layer based on performance information 620 corresponding to the second layer. According to an exemplary embodiment, the compression technique may be determined based on a quantitative numerical value of the performance information corresponding to the layer.

In an exemplary embodiment, based on the performance information 610 corresponding to the first layer in which values of the Y axis and the Z axis are the largest among the performance information 610 corresponding to the first layer, the performance information 620 corresponding to the second layer, and the performance information 630 corresponding to the third layer, the first layer may be determined as a layer in which compression efficiency is the best upon compressing the model. The second layer and the third layer may have a lower priority than the first layer, but may be determined as layers capable of compressing the model.

In an exemplary embodiment, since performance information 640 corresponding to the fourth layer and performance information 650 corresponding to the fifth layer are not distinguishably displayed able to be optimized, the fourth layer and the fifth layer may not be considered in the process of compressing the model.

In an exemplary embodiment, the size of the input data of the corresponding model may be determined based on the performance information related to the latency of the first layer. For example, the size of the input data may have a positive correlation with the performance information related to the latency of the first layer.

In an exemplary embodiment, each of the layer identification information on the benchmark result 600 and/or the performance information corresponding to the layer may correspond to the visual element. In response to the user selection for the visual element, the computing device 100 may provide additional performance information and/or specific performance information for the selected visual element. Additionally, when the visual element corresponding to the layer identification information on the benchmark result 600 is selected, layers having identification information corresponding to the corresponding identification information may be listed, and latencies corresponding to the listed layers may be provided.

As illustrated in FIG. 6, since the user interface according to an exemplary embodiment of the present disclosure is provided so as for the user to intuitively judge through various conditions and various comparison options, a technical effect that the benchmark result may be utilized in more various aspects and more efficiently may be achieved.

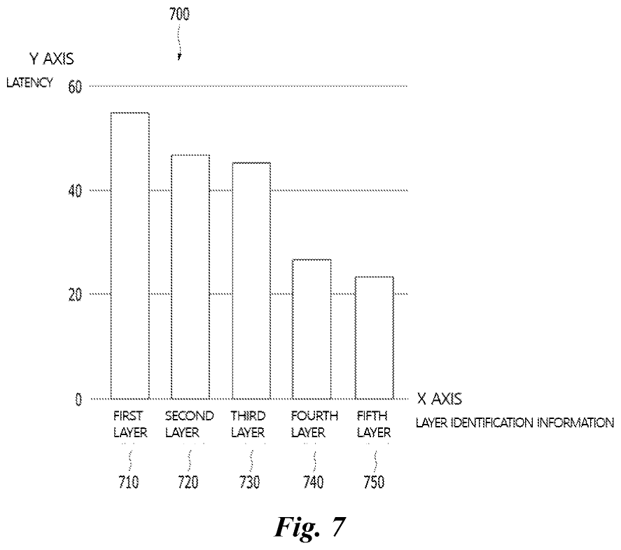

FIG. 7 illustratively illustrates a benchmark result 700 to which a visual element is applied according to an exemplary embodiment of the present disclosure.

In an exemplary embodiment, when the benchmark configuration setting includes an option of comparing performances of the plurality of layers constituting the target model, the computing device 100 may generate a benchmark result 700 illustrated in FIG. 7.

As illustrated in FIG. 7, the benchmark result 700 may include a 2D graph constituted by X and Y axes. Here, the X axis may indicate layer identification information and the Y axis may indicate performance information (e.g., latency) for each of the layers. For example, a unit of the Y axis may include various time units such as millisecond (ms) and/or second(s).

As an example, the performance information may include an actually measured result in response to reception of a benchmark query corresponding to the benchmark result 700. As another example, the performance information may include anticipated performance information generated based on pre-measured performance information before receiving the benchmark query corresponding to the benchmark result 700.

As illustrated in FIG. 7, the benchmark result 700 may include a 2D graph constituted by X and Y axes. Here, the X axis may indicate layer identification information and the Y axis may indicate performance information (e.g., latency) for each of the layers. For example, a unit of the Y axis may include various time units such as millisecond (ms) and/or second(s).

As an example, the performance information may include an actually measured result in response to reception of a benchmark query corresponding to the benchmark result 700. As another example, the performance information may include anticipated performance information generated based on pre-measured performance information before receiving the benchmark query corresponding to the benchmark result 700.

As illustrated in FIG. 7, the benchmark result 700 may quantitatively comparatively display latencies for a first layer 710, a second layer 720, a third layer 730, a fourth layer 740, and a fifth layer 750, respectively. In the example of FIG. 7, the benchmark result 700 may comparatively display the latencies by the unit of the layer so that output layers are aligned based on the size of the latency. As a result, the layer are listed to correspond to an order of a high latency, which may help the user select layers which need to be intuitively optimized and/or compressed.

The benchmark result 700 in FIG. 7 may include a user interface of a form in which only layers which are able to be optimized are listed in a form of excluding layers which are not able to be optimized. For example, when the benchmark configuration setting includes an option for determining a compression target and/or a compression technique, the computing device 100 may determine displaying layers other than the layers which are not able to be optimized as illustrated in FIG. 7.

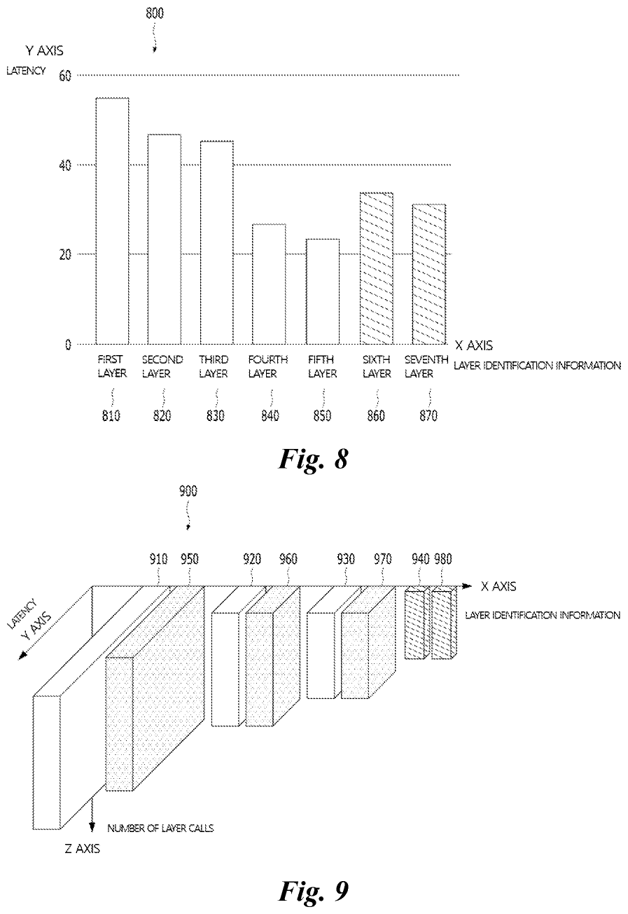

FIG. 8 illustratively illustrates a benchmark result 800 to which a visual element is applied according to an exemplary embodiment of the present disclosure.

In an exemplary embodiment, when the benchmark configuration setting includes an option of comparing performances of the plurality of layers constituting the target model, the computing device 100 may generate a benchmark result 800 illustrated in FIG. 8.

Here, the X axis may indicate layer identification information and the Y axis may indicate performance information (e.g., latency) for each of the layers. As an example, the performance information may include an actually measured result in response to reception of a benchmark query corresponding to the benchmark result 800. As another example, the performance information may include anticipated performance information generated based on pre-measured performance information before receiving the benchmark query corresponding to the benchmark result 800.

As illustrated in FIG. 8, the benchmark result 800 may quantitatively comparatively display latencies for a first layer 810, a second layer 820, a third layer 830, a fourth layer 840, a fifth layer 850, a sixth layer 860, and a seventh layer 870, respectively.

In FIG. 8, a first group of the first layer 810, the second layer 820, the third layer 830, the fourth layer 840, and the fifth layer 850, and a second group of the sixth layer 860 and the seventh layer 870 may be displayed to be visually distinguished from each other. The first group may indicate the layer which is able to be optimized and the second group may indicate the layer which is not able to be optimized. A quantitative value of the latency and which layer is able to be optimized may be intuitively confirmed through the size of the graph on the benchmark result 800.

In an exemplary embodiment, the benchmark result 800 may be used for determining a compression technique suitable for each type of layer. For example, a first compression technique may be used for the first layer based on performance information 810 corresponding to the first layer, and a second compression technique different from the first compression technique may be used for the second layer based on performance information 820 corresponding to the second layer. According to an exemplary embodiment, the compression technique may be determined based on a quantitative numerical value of the performance information corresponding to the layer.

In the example of FIG. 8, the benchmark result 800 may comparatively display the latencies by the unit of the layer so that output layers are aligned based on the size of the latency. As a result, the layer are listed to correspond to an order of a high latency, which may help the user select layers which need to be intuitively optimized and/or compressed. In an exemplary embodiment, the computing device 100 may perform an alignment of the layers of the first group which are able to be optimized and an alignment of the layers of the second group which are not able to be optimized independently from each other. As illustrated in FIG. 8, the alignment according to the size of the value of the latency may be independently performed for each of the first group and the second group. As such, a technical effect may be achieved in which more intuitive information may be provided to the user by performing the alignment based on the performance information for the layers that are not able to be optimized.

In an exemplary embodiment, based on performance information corresponding to the first layer 810 in which the value of the Y axis is the largest on the benchmark result 800, the first layer may be determined as a layer in which compression efficiency is the best upon compressing the model. The second layer 820, the third layer 830, the fourth layer 840, and the fifth layer 850 may have a lower priority than the first layer 810, but may be determined as a compressible layer.

FIG. 9 illustratively illustrates a benchmark result 900 to which a visual element is applied according to an exemplary embodiment of the present disclosure.

In an exemplary embodiment, the when the benchmark configuration setting includes an option of comparing performances of the plurality of layers and the plurality of nodes constituting the target model, the computing device 100 may generate a benchmark result 900 illustrated in FIG. 9.

As illustrated in FIG. 9, the benchmark result 900 may include a 3D graph constituted by X, Y, and Z axes. Here, the X axis may indicate layer identification information, the Y axis may indicate first performance information (e.g., latency) for each of the layers, and the Z axis may indicate second performance information (e.g., the number of calls during an inference process) for each of the layers. The latency corresponding to the first performance information may represent a total inference time according to a layer type. The number of calls corresponding to the second performance information may represent a total number of calls according to the layer type. Here, the total inference time and the total number of calls may be used as a meaning that encompasses measurement information during a single inference process or measurement information aggregated in a plurality of inferences.

As an example, the first performance information and the second performance information may include an actually measured result in response to reception of a benchmark query corresponding to the benchmark result 900. As another example, the first performance information and the second performance information may include anticipated performance information generated based on pre-measured performance information before receiving the benchmark query corresponding to the benchmark result 900.

In an exemplary embodiment, the benchmark result 900 may display respective nodes to be visually distinguished so as to compare performance information for the plurality of respective nodes. As illustrated in FIG. 9, layers 910, 920, and 930 corresponding to the first node and layers 950, 960, and 970 corresponding to the second node may be displayed to be visually distinguished. As a result, node-wise performance information may be intuitively confirmed.

In an exemplary embodiment, as illustrated in FIGS. 6 and 8, the benchmark result 900 may display layers 910, 920, 930, 950, 960, and 970 (the layers of the first group) which are able to be optimized and layers 940 and 980 (the layers of the second group) which are not able to be optimized to be visually distinguished. In an exemplary embodiment, the computing device 100 may perform an alignment of the layers of the first group which are able to be optimized and an alignment of the layers of the second group which are not able to be optimized independently from each other. As illustrated in FIG. 9, the alignment according to the size of the value of the latency may be independently performed for each of the first group and the second group. As such, a technical effect may be achieved in which more intuitive information may be provided to the user by performing the alignment based on the performance information for the layers which are able to be optimized.

In an exemplary embodiment, the alignment between the layers may be implemented for each node. By aligning the layers based on the performance information for the layers for each node, the technique according to an exemplary embodiment may allow the user to intuitively compare the performance information of the nodes, and more easily review compressibility of the layers.

As illustrated in FIG. 9, the technique according to an exemplary embodiment of the present disclosure may intuitively display which type of layer has a faster operation speed according to each of the nodes, and as a result, relative performance information between the nodes may be efficiently confirmed. The technique according to an exemplary embodiment of the present disclosure may allow the model to be optimized or compressed by different schemes according to the node.

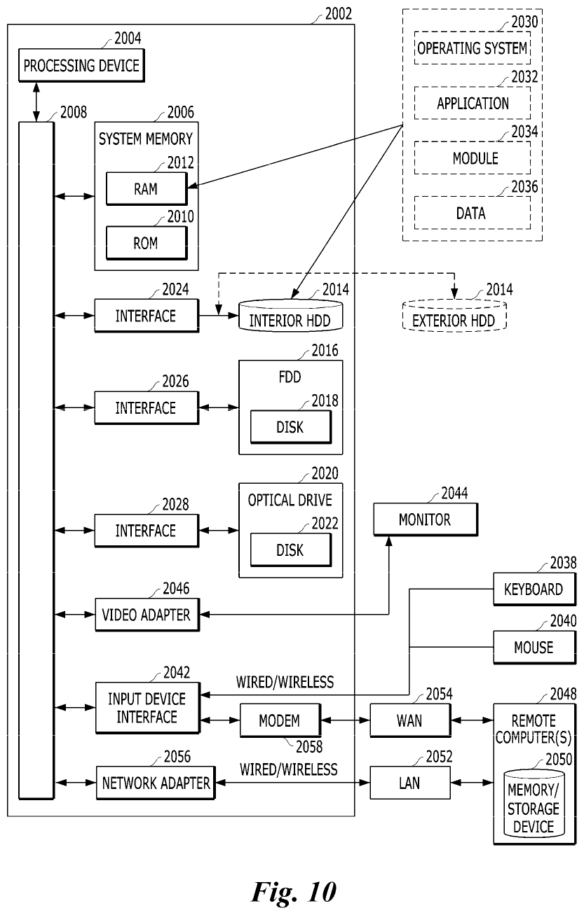

FIG. 10 is a schematic view of a computing environment of the computing device 100 according to an exemplary embodiment of the present disclosure.

In the present disclosure, the component, the module, or the unit includes a routine, a procedure, a program, a component, and a data structure that perform a specific task or implement a specific abstract data type. Further, it will be well appreciated by those skilled in the art that the methods presented by the present disclosure can be implemented by other computer system configurations including a personal computer, a handheld computing device, microprocessor-based or programmable home appliances, and others (the respective devices may operate in connection with one or more associated devices) as well as a single-processor or multi-processor computing device, a mini computer, and a main frame computer.

The embodiments described in the present disclosure may also be implemented in a distributed computing environment in which predetermined tasks are performed by remote processing devices connected through a communication network. In the distributed computing environment, the program module may be positioned in both local and remote memory storage devices.

The computing device generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media.

The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable instruction, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 2000 that implements various aspects of the present disclosure including a computer 2002 is shown and the computer 2002 includes a processing device 2004, a system memory 2006, and a system bus 2008. The computer 200 in the present disclosure may be used intercompatibly with the computer device 100. The system bus 2008 connects system components including the system memory 2006 (not limited thereto) to the processing device 2004. The processing device 2004 may be a predetermined processor among various commercial processors. A dual processor and other multi-processor architectures may also be used as the processing device 2004.

The system bus 2008 may be any one of several types of bus structures which may be additionally interconnected to a local bus using any one of a memory bus, a peripheral device bus, and various commercial bus architectures. The system memory 2006 includes a read only memory (ROM) 2010 and a random access memory (RAM) 2012. A basic input/output system (BIOS) is stored in the non-volatile memories 2010 including the ROM, the EPROM, the EEPROM, and the like and the BIOS includes a basic routine that assists in transmitting information among components in the computer 2002 at a time such as in-starting. The RAM 2012 may also include a high-speed RAM including a static RAM for caching data, and the like.

The computer 2002 also includes an internal hard disk drive (HDD) 2014 (for example, EIDE and SATA), a magnetic floppy disk drive (FDD) 2016 (for example, for reading from or writing in a mobile diskette 2018), SSD and an optical disk drive 2020 (for example, for reading a CD-ROM disk 2022 or reading from or writing in other high-capacity optical media such as the DVD). The hard disk drive 2014, the magnetic disk drive 2016, and the optical disk drive 2020 may be connected to the system bus 2008 by a hard disk drive interface 2024, a magnetic disk drive interface 2026, and an optical drive interface 2028, respectively. An interface 2024 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 2002, the drives and the media correspond to storing of predetermined data in an appropriate digital format. In the description of the computer readable storage media, the mobile optical media such as the HDD, the mobile magnetic disk, and the CD or the DVD are mentioned, but it will be well appreciated by those skilled in the art that other types of storage media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 2030, one or more application programs 2032, other program module 2034, and program data 2036 may be stored in the drive and the RAM 2012. All or some of the operating system, the application, the module, and/or the data may also be cached in the RAM 2012. It will be well appreciated that the present disclosure may be implemented in operating systems which are commercially usable or a combination of the operating systems.

A user may input instructions and information in the computer 2002 through one or more wired/wireless input devices, for example, pointing devices such as a keyboard 2038 and a mouse 2040. Other input devices (not illustrated) may include a microphone, an IR remote controller, a joystick, a game pad, a stylus pen, a touch screen, and others. These and other input devices are often connected to the processing device 2004 through an input device interface 2042 connected to the system bus 2008, but may be connected by other interfaces including a parallel port, an IEEE 1394 serial port, a game port, a USB port, an IR interface, and others.

A monitor 2044 or other types of display devices are also connected to the system bus 2008 through interfaces such as a video adapter 2046, and the like. In addition to the monitor 2044, the computer generally includes a speaker, a printer, and other peripheral output devices (not illustrated).

The computer 2002 may operate in a networked environment by using a logical connection to one or more remote computers including remote computer(s) 2048 through wired and/or wireless communication. The remote computer(s) 2048 may be a workstation, a server computer, a router, a personal computer, a portable computer, a micro-processor based entertainment apparatus, a peer device, or other general network nodes and generally includes multiple components or all of the components described with respect to the computer 2002, but only a memory storage device 2050 is illustrated for brief description. The illustrated logical connection includes a wired/wireless connection to a local area network (LAN) 2052 and/or a larger network, for example, a wide area network (WAN) 2054. The LAN and WAN networking environments are general environments in offices and companies and facilitate an enterprise-wide computer network such as Intranet, and all of them may be connected to a worldwide computer network, for example, the Internet.

When the computer 2002 is used in the LAN networking environment, the computer 2002 is connected to a local network 2052 through a wired and/or wireless communication network interface or an adapter 2056. The adapter 2056 may facilitate the wired or wireless communication to the LAN 2052 and the LAN 2052 also includes a wireless access point installed therein in order to communicate with the wireless adapter 2056. When the computer 2002 is used in the WAN networking environment, the computer 2002 may include a modem 2058, is connected to a communication server on the WAN 2054, or has other means that configure communication through the WAN 2054 such as the Internet, etc. The modem 2058 which may be an internal or external and wired or wireless device is connected to the system bus 2008 through the serial port interface 2042. In the networked environment, the program modules described with respect to the computer 2002 or some thereof may be stored in the remote memory/storage device 2050. It will be well known that an illustrated network connection is exemplary and other means configuring a communication link among computers may be used.

The computer 2002 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Method claims provide elements of various steps in a sample order, but the method claims are not limited to the presented specific order or hierarchical structure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for providing a benchmark result, performed by a computing device, comprising:
obtaining a benchmark object comprising an artificial intelligence-based target model and a target node, and obtaining a benchmark configuration setting indicating a customization of the benchmark result, wherein the benchmark configuration setting comprises at least one of: a resource condition for the target mode, a first comparison option for benchmark results of each of a plurality of layers constituting the target model, or a second comparison option for benchmark results of each of a plurality of nodes comprising the target node; and
providing the benchmark result based on the configuration setting, the target model, and the target node, and
wherein the first comparison option is an option for visually comparing benchmark results for each of the plurality of layers within the target model at the target node, and wherein the benchmark results comprise performance information corresponding to each of the plurality of layers constituting the target model.

2. The method of claim 1, wherein the resource condition for the target node comprises: a condition related to a use of computing resources by applications other than an inference application of the target model on the target node, or a condition related to a use of computing resources by operations other than an inference operation of the target model on the target node, when inference of the target model is executed on the target node, and
wherein the benchmark result comprises performance information obtained by executing the target model on the target node, assuming a computing resource situation corresponding to the resource condition.

3. The method of claim 1, wherein the resource condition for the target node comprises: a condition related to an occupancy of computing resources being used on the target node, when inference of the target model is to be executed on the target node.

4. The method of claim 1, wherein the resource condition for the target node identifies a computing resource to be included in the benchmark result, when inference of the target model is to be executed on the target node.

5. The method of claim 1, wherein the benchmark result comprises a benchmark estimation result predicted when the target model is executed in the target node.

6. The method of claim 1, wherein the second comparison option is an option for visually comparing benchmark results for the target model at each of the plurality of nodes comprising the target node, or an option for visually comparing benchmark results for each of the plurality of layers within the target model at each of the plurality of nodes comprising the target node.

7. The method of claim 1, wherein the benchmark configuration setting further comprises a third comparison option for visually comparing benchmark results for each of a plurality of models comprising the target model at the target node.

8. The method of claim 1, wherein the benchmark result comprises the number of calls to each of the plurality of layers, and latencies for each of the plurality of layers.

9. The method of claim 1, wherein a layer that is able to be optimized and a layer that is not able to be optimized, for each of a plurality of layers constituting an artificial intelligence-based model, are distinguishably displayed in the benchmark result.

10. The method of claim 1, wherein the benchmark result comprises:
preprocessing time information required for preprocessing of inference of the target model at the target node, or inference time information required for inference of the target model at the target node; and
preprocessing memory usage information used for preprocessing of inference of the target model at the target node, or inference memory usage information required for inference of the target model at the target node.

11. The method of claim 1, wherein the benchmark result comprises:
memory footprint information required for executing the target model at the target node;
latency information required for executing the target model at the target node; and
power consumption information required for executing the target model at the target node.

12. The method of claim 1, wherein the benchmark result comprises at least one of:
a first result comparatively indicating maximum inference latencies obtained by executing the target model assuming the slowest computing resource situation at each of the plurality of nodes comprising the target node;
a second result comparatively indicating an average inference latency when the target model is executed multiple times at each of the plurality of nodes comprising the target node; or
a third result comparatively indicating inference latencies for each of a plurality of layers within the target model at each of the plurality of nodes comprising the target node.

13. The method of claim 1, wherein the benchmark result comprises:
a fourth result comparatively indicating a processor margin value in which another operation or another application is executable in a process of inferring the target model at the target node; and
a fifth result comparatively indicating a memory margin value in which another operation or another application is executable in a process of inferring the target model at the target node.

14. The method of claim 1, wherein the providing the benchmark result comprises:
determining a visual element to be included in the benchmark result based on the benchmark configuration setting;
obtaining performance information to be included in the benchmark result based on the target model and the target node; and
providing the benchmark result in which the performance information is indicated depending on the visual element.

15. The method of claim 14, wherein the visual element comprises:
information identifying each of a plurality of axes to be included in the benchmark result; and
information identifying a graph shape to be included in the benchmark result.

16. The method of claim 1, wherein the providing the benchmark result comprises:
providing, to a first module, the benchmark result comprising performance information corresponding to an input layer of the plurality of layers so that the first module which trains the target model can determine a size of input data of the target model; or
providing, to a second module, the benchmark result comprising performance information for each of the plurality of layers so that the second module which generates a compressed target model by compressing the target model can determine whether to compress each of the plurality of layers of the target model.

17. The method of claim 1, further comprising:
obtaining importance level information corresponding to visual elements to be included in the benchmark result; and
providing a candidate node list comprising candidate nodes recommended for determining the target node, by using pre-obtained benchmark results for each of a plurality of nodes based on the importance level information.

18. The method of claim 1, wherein the benchmark configuration setting further comprises target area information for identifying a target area which is an object of a benchmark within the target model, and wherein the benchmark result comprises estimated performance information corresponding to the identified target area when the benchmark is performed at the target node.

19. A non-transitory computer readable medium comprising a computer program, wherein the computer program allows a computing device to perform following operations to provide a benchmark result when executed by the computing device, and wherein the operations comprise:
obtaining a benchmark object comprising an artificial intelligence-based target model and a target node, and obtaining a benchmark configuration setting indicating a customization of the benchmark result, wherein the benchmark configuration setting comprises at least one of: a resource condition for the target node, a first comparison option for benchmark results of each of a plurality of layers constituting the target model, or a second comparison option for benchmark results of each of a plurality of nodes comprising the target node; and
providing the benchmark result based on the configuration setting, the target model, and the target node, and
wherein the first comparison option is an option for visually comparing benchmark results for each of the plurality of layers within the target model at the target node, and wherein the benchmark results comprise performance information corresponding to each of the plurality of layers constituting the target model.

20. A computing device for providing a benchmark result, comprising:
at least one processor; and
a memory coupled to the at least one processor,
wherein the at least one processor, in operation:
obtains a benchmark object comprising an artificial intelligence-based target model and a target node, and obtaining a benchmark configuration setting indicating a customization of the benchmark result, wherein the benchmark configuration setting comprises at least one of: a resource condition for the target node, a first comparison option for benchmark results of each of a plurality of layers constituting the target model, or a second comparison option for benchmark results of each of a plurality of nodes comprising the target node; and
provides the benchmark result based on the configuration setting, the target model, and the target node, and
wherein the first comparison option is an option for visually comparing benchmark results for each of the plurality of layers within the target model at the target node, and wherein the benchmark results comprise performance information corresponding to each of the plurality of layers constituting the target model.
